(19) United States
(12) Patent Application Publication
(10) Pub. No.: US 2025/0218014 A1
(43) Pub. Date: Jul. 3, 2025

(54) STORING DEPTH INFORMATION

(71) Applicant: QUALCOMM Incorporated, San Diego, CA (US)

(72) Inventors: Meng-Lin WU, San Diego, CA (US); Xiaoliang BAI, San Diego, CA (US); Sandesh GHIMIRE, San Diego, CA (US); Xitong ZHANG, San Diego, CA (US)

(21) Appl. No.: 18/403,249

(22) Filed: Jan. 3, 2024

(51) Int. Cl. G06T 7/521; G06T 5/70

(52) U.S. Cl. CPC G06T 7/521; G06T 5/70; G06T 2207/10028

(57) ABSTRACT

Systems and techniques are described herein for storing depth information. For instance, a method for storing depth information is provided. The method may include obtaining depth information for depth pixels of a depth map; determining, based on the depth information, a respective plurality of depth values for each depth pixel of the depth map; and storing the respective plurality of depth values for each depth pixel of the depth map.

### TECHNICAL FIELD

The present disclosure generally relates processing depth information. For example, aspects of the present disclosure include systems and techniques for storing depth values (e.g., representing distances between a device and points in an environment of the device) in a depth map.

### BACKGROUND

A device may determine distances (or depths) between the device and points in an environment of the device. The device may determine a number (e.g., hundreds or thousands) of depths and arrange the depths as depth values in depth pixels of a depth map. The depth map may be a two-dimensional map of depth pixels. The depth map may be representation of a three-dimensional environment (e.g., from the perspective of the device). For example, an environment may be modeled by projecting a respective ray from a focal point of the device through each depth pixel of a depth map (each ray having a length corresponding to the depth value).

There are a number of techniques for determining depths. Examples include projection-based depth-estimation techniques, such as light ranging and detection (LIDAR)-based techniques, radio detection and ranging (RADAR)-based techniques, and time-of-flight (ToF) techniques (including direct time-of-flight (dToF)-based techniques and indirect time-of-flight (iToF)-based techniques). Other examples include keypoint-matching-based depth-estimation techniques, such as structure-light techniques and depth-from-stereo (DFS) techniques. Machine-learning-based depth-estimation techniques may also be used to determine depths.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for storing depth information. According to at least one example, a method is provided for storing depth information. The method includes: obtaining depth information for depth pixels of a depth map; determining, based on the depth information, a respective plurality of depth values for each depth pixel of the depth map; and storing the respective plurality of depth values for each depth pixel of the depth map

In another example, an apparatus for storing depth information is provided that includes at least one memory and at least one processor (e.g., configured in circuitry) coupled to the at least one memory. The at least one processor configured to: obtain depth information for depth pixels of a depth map; determine, based on the depth information, a respective plurality of depth values for each depth pixel of the depth map; and store the respective plurality of depth values for each depth pixel of the depth map.

In another example, a non-transitory computer-readable medium is provided that has stored thereon instructions that, when executed by one or more processors, cause the one or more processors to: obtain depth information for depth pixels of a depth map; determine, based on the depth information, a respective plurality of depth values for each depth pixel of the depth map; and store the respective plurality of depth values for each depth pixel of the depth map.

In another example, an apparatus for storing depth information is provided. The apparatus includes: means for obtaining depth information for depth pixels of a depth map; means for determining, based on the depth information, a respective plurality of depth values for each depth pixel of the depth map; and means for storing the respective plurality of depth values for each depth pixel of the depth map.

In some aspects, one or more of the apparatuses described herein is, can be part of, or can include an extended reality device (e.g., a virtual reality (VR) device, an augmented reality (AR) device, or a mixed reality (MR) device), a vehicle (or a computing device, system, or component of a vehicle), a mobile device (e.g., a mobile telephone or so-called “smart phone”, a tablet computer, or other type of mobile device), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example projection-based depth-estimation system, according to various aspects of the present disclosure;

FIG. 2 is a depiction of an example structured light depth-sensing system, according to various aspects of the present disclosure;

FIG. 3 illustrates two example images, which may be used to determine depth information according to a depth-from-stereo (DFS) depth-estimation technique;

FIG. 4 illustrates two example images and an example associated cost function, according to various aspects of the present disclosure;

FIG. 5 is a block diagram illustrating an example system that implements a machine-learning-based depth-estimation technique, according to various aspects of the present disclosure;

FIG. 6 is a block diagram illustrating an example system for storing depth information, according to various aspects of the present disclosure;

FIG. 7 includes two histograms which illustrate two example distribution profiles of depth values;

FIG. 8 includes the two histograms of FIG. 7 and additional lines to illustrate various depth values;

FIG. 9 includes three representations of depth values, according to various aspects of the present disclosure;

FIG. 10 includes three representations of depth values, according to various aspects of the present disclosure;

FIG. 11 is a block diagram illustrating an example system for modifying an image based on depth values, according to various aspects of the present disclosure;

FIG. 12 includes an example image and an example modified image, according to various aspects of the present disclosure;

FIG. 13 is a block diagram illustrating an example system for refining a depth map based on depth values or for generating a refined depth map based on depth values, according to various aspects of the present disclosure;

FIG. 14 illustrates results of a depth refining process, according to various aspects of the present disclosure;

FIG. 15 is a block diagram illustrating an example system for generating a refined depth map based on depth values, according to various aspects of the present disclosure;

FIG. 16 illustrates results of a depth refining process, according to various aspects of the present disclosure;

FIG. 17 is a flow diagram illustrating an example process for storing depth values, in accordance with aspects of the present disclosure;

FIG. 18 is a block diagram illustrating an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

As mentioned above, there are a number of techniques for determining distances between sensors (e.g., depth sensors and/or cameras) and points in an environment (e.g., depths). In the present disclosure, a distance between a device and a point in the environment may be referred to as a “depth.” Examples of techniques for determining distances include projection-based depth-estimation techniques (e.g., light ranging and detection (LIDAR)-based techniques, radio detection and ranging (RADAR)-based techniques, and time-of-flight (ToF) techniques, including direct time-of-flight (dToF)-based techniques and indirect time-of-flight (iToF)-based techniques), keypoint-matching-based depth-estimation techniques (e.g., structured-light techniques and depth-from-stereo (DFS) techniques), and machine-learning-based depth-estimation techniques. Such techniques may generate depth maps with a number (e.g., hundreds or thousands) of depth values (also referred to as depth pixels) arranged into a two-dimensional array. A depth map may represent a three-dimensional environment (e.g., from the perspective of the sensors).

In some cases, one or more depth values of a depth map may be inaccurate or complicated. For example, a depth pixel of a depth sensor (e.g., a projection-based depth sensor) may capture reflections from two points in a scene. For instance, a single depth pixel of a depth sensor may receive a reflection from an edge of an object and from a point behind the edge of the object (e.g., based on the resolution of the depth sensor). As another example, a single depth pixel may receive a reflection from a translucent surface (e.g., glass) and a reflection from a point behind the translucent surface. As another example, a single depth pixel may receive a reflection from a reflective surface (e.g., a mirror) and a reflection from a point that arrived at the sensor via a reflection at the reflective surface. As another example, a single depth pixel may receive a first reflection with a first timing difference from a point on a specular surface in a scene at a first time. The depth pixel may receive a second reflection with a second, different timing difference from the same point on the specular surface at a second time (e.g., based on the way the specular surface reflects light). Projection-based depth-estimation technique may be subject to noise, and/or multipath reflections. As such projection-based depth-estimation techniques may generate confidence metrics (e.g., confidence intervals) and/or metrics based on return signal strength.

As another example, in the case of a keypoint-matching-based depth-estimation technique, multiple keypoints of images may match resulting in ambiguity regarding a depth of the keypoints of the scene. As another example, a machine-learning depth predictor may estimate a depth and determine a confidence relative to the estimated depth. As such, keypoint-matching-based depth-estimation techniques and/machine-learning-based depth-estimation techniques may generate confidence metrics (e.g., confidence intervals).

Conventional depth-determining techniques generate depth maps including one depth value per depth pixel of the depth map. Each depth pixel of a depth map may correspond to a respective depth pixel of a depth sensor. Alternatively, each depth pixel of a depth map may correspond to an image pixel (or a number of image pixels) of images on which the depth map is based (e.g., in keypoint-matching-based depth-estimation techniques and machine-learning-based depth-estimation techniques). Such depth-determining techniques may, in the cases of complicated depth values (e.g., depth values based on different reflections or multiple matching keypoints) determine one depth value for each depth pixel of a depth map. In some cases, the depth-determining techniques may average between values or select one of the values (e.g., a closest of the depth values). Some depth-determining techniques may generate confidence values for complicated depth values. Such confidence values may flag depth values that are complicated such that downstream users of the depth map may use the complicated depth values with appropriate caution.

Storing only a single depth value per depth pixel may waste depth information that could otherwise be usable. For example, depth pixels may be larger than image pixels (e.g., the resolution of a depth-determination technique may be less than the resolution of a camera). Modifying an image (e.g., according to a synthetic Bokeh process) based on a depth map of a lower resolution may result in errors. For example, a depth pixel may correspond to several image pixels. The several image pixels may represent different depths within a scene. However, if the depth pixel includes only one depth value, in the modifying process, all of the several image pixels may be modified based on the one depth value. As another example, reflections may also result in errors when an image is modified based on a depth map with a single depth value per depth pixel. For example, a reflection in an image may be modified according to a foreground depth when instead, it should be modified according to a background depth.

Systems, apparatuses, methods (also referred to as processes), and computer-readable media (collectively referred to herein as “systems and techniques”) are described herein for storing depth information. For example, the systems and techniques described herein may obtain multiple depth values (e.g., tens of depth values) for each depth pixel of a depth map. The systems and techniques may, based on the multiple depth values, determine three (or more) depth values for each depth pixel of the depth map. Further, the systems and techniques may store the three (or more) depth values for each depth pixel of the depth map. In this way, the systems and techniques may generate a depth map including three (or more) depth values for each depth pixel of the depth map.

In some cases, a distribution profile (e.g., which can be presented as a histogram) of the multiple depth values of a given depth pixel may include a single peak. For example, a majority of the depth values of a given depth pixel may fall within a threshold distance of each other. This may be referred to herein as a single-peak distribution profile. A single-peak distribution profile may be the result of, for example, reflections from diffuse surfaces, sloped surfaces, and/or fine details. Additionally or alternatively, a single-peak distribution profile may be the result of a keypoint-matching-based depth-estimation technique matching multiple keypoints that are close to each other in the image or images (e.g., based on a visually uniform surface).

The systems and techniques may examine the multiple depth values of each depth pixel and determine whether the multiple depth values exhibit to a single-peak distribution profile. For depth pixels for which the multiple depth values exhibit a single-peak distribution profile, the systems and techniques may determine the three depth values to store such that the three depth values represent a confidence interval of the multiple depth values and an additional metric of the multiple depth values. For example, the three depth values may include a low depth value and a high depth value. The low depth value and the high depth value may together describe a confidence interval for the multiple depth values. For example, the low depth value and the high depth value may be determined such that 90% or 95% of the multiple depth values fall between the low depth value and the high depth value. Additionally the third depth value may represent an additional metric related to the multiple depth values. For example, the third depth value may represent an average of the multiple depth values, a mean of the multiple depth values, or a likely (e.g., most likely as determined by another technique) depth of the multiple depth values.

In some cases, a distribution profile of the multiple depth values of a give depth pixel may include multiple peaks. For example, the distribution profile of the multiple depth values may exhibit a bimodal distribution (e.g., having two peaks). This may be referred to herein as a multi-peak distribution profile. A multi-peak distribution profile may be the result of, for example, reflections from an edge (e.g., a depth discontinuity), reflections from specular surfaces, semi-transparent surfaces, and/or fine details. Additionally or alternatively, a multi-peak distribution profile may be the result of a keypoint-matching-based depth-estimation technique matching multiple keypoints that are separate from each other in the image or images (e.g., based on pattern repeated at distances within the scene, such as wallpaper or a visually uniform surface illuminated by a repeating pattern).

The systems and techniques may examine the multiple depth values of each depth pixel and determine whether the multiple depth values exhibit a multi-peak distribution profile. For depth pixels for which the multiple depth values exhibit a multi-peak distribution profile, the systems and techniques may determine the three depth values to store such that the three depth values represent modes of two of the peaks and an additional metric. For example, the three depth values may include a low depth value and a high depth value. The low depth value may be based on a mode or median of a distribution profile of depth values a closer of the two largest peaks. The high depth value may be based on a mode or median of the distribution profile of depth values a farther away of the two largest peaks. Additionally the third depth value may represent an additional metric related to the multiple depth values. For example, the third depth value may represent a count of a mode of the distribution profile of the multiple depth values. Alternatively, the third depth value may be based on a reflectivity of a point in a scene corresponding to the depth pixel, an opacity of the point in the scene corresponding to the depth pixel, a pixel coverage between a foreground and a background, or a confidence related to the low depth value and/or the high depth value.

By storing multiple depth values for each depth pixel of a depth map, the systems and techniques may preserve depth information that would be lost if only one depth value per depth pixel were stored. The preserved depth information may allow downstream users of depth information to more effectively use the depth map. Further, by selecting depth values to store such that the depth values represent statistical measures, the systems and techniques may ensure that useful information is stored, for example, for downstream users.

Various aspects of the application will be described with respect to the figures below.

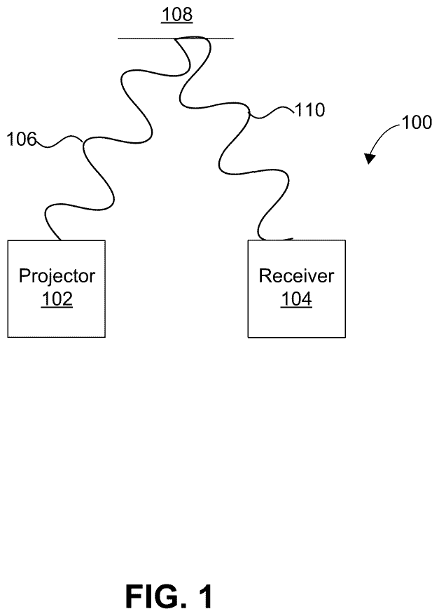

FIG. 1 is a diagram illustrating an example projection-based depth-estimation system (system 100), according to various aspects of the present disclosure. System 100 may be, or may include, for example, a light ranging and detection (LIDAR)-based system, a radio detection and ranging (RADAR)-based system a direct time-of-flight (dToF) system or an indirect time-of-flight (iToF) system.

As a LIDAR system, a RADAR system, or a dToF depth system, system 100 may measure a timing difference (e.g., a time of flight) between when emitted light pulse 106 is emitted by projector 102 and when reflected light pulse 110 received by receiver 104 (e.g., after emitted light pulse 106 has been reflected by object 108 in an environment). Although illustrated as spread apart in FIG. 1, projector 102 and receiver 104 may be collocated, beside one another, or interspersed with one another. As a LIDAR system, a RADAR system, or a dToF depth system, system 100 may, based on the time of flight and the speed of light, calculate a distance between the system 100 and object 108 in the environment. As used here, the term “light” may refer to any portion of the electromagnetic spectrum including, as examples, visible light, infrared light, and/or radio waves.

As an iToF depth camera, System 100 may measure a phase difference between emitted light pulse 106 as emitted by projector 102 and reflected light pulse 110 as received by receiver 104. System 100 may relate the phase difference to a time of flight of emitted light pulse 106 between emission and reception, based on the speed of light and the frequency of the light pulse. As an iToF depth camera, System 100 may, based on the time of flight and the speed of light, calculate a distance between system 100 and object 108 in the environment.

IToF depth cameras may experience aliasing based on the wavelength of emitted light pulse 106. Aliasing may result in multi-peak distribution profiles.

System 100 may emit one more light pulses into the environment and determine depth information relative to the environment. For example, projector 102 may emit one or more light pulses and receive and focus reflected light pulses onto an array of sensors of receiver 104. The array of depth sensors may include a number of independent depth sensors arranged as depth pixels. Each depth pixel may correspond to a ray between the depth pixel and the environment. For example, reflections along a given ray may be focused onto a given depth pixel. System 100 may store depth information recorded by various sensors as depth values of depth pixels of a depth map.

Additionally or alternatively, projector 102 and receiver 104 may scan the environment. For example, projector 102 may project emitted light pulse 106 into the environment at a given angle and receiver 104 may receive reflected light pulse 110 from the environment. Projector 102 may change angles, for example, scanning the environment, and receiver 104 may track reflected light pulse 110 from various angles of projector 102. System 100 may store depth information from various angles as depth values of depth pixels of a depth map.

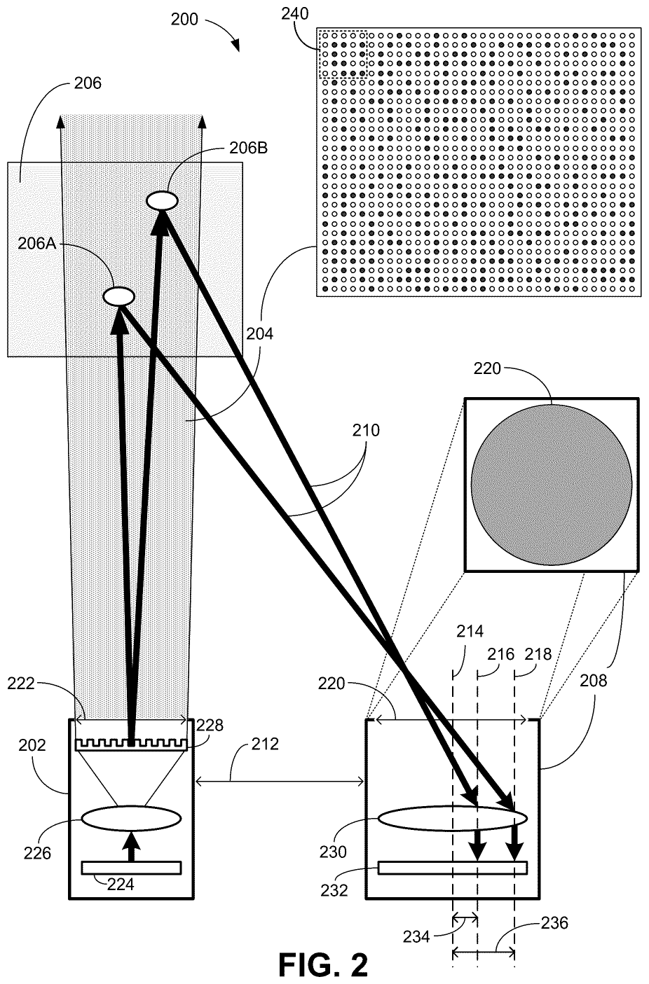

FIG. 2 is a depiction of an example structured light depth-sensing system 200 (system 200), according to various aspects of the present disclosure. In some aspects, the system 200 can perform a keypoint-matching-based depth-estimation technique as described herein. System 200 may use a pattern 204 of dots for determining depths of objects 206A and 206B in a scene 206, according to various aspects of the present disclosure. System 200 may be used to generate a depth map (not illustrated in FIG. 2) of a scene 206. For example, the scene 206 may include an object (e.g., a face), and system 200 may be used to generate a depth map including a plurality of depth values indicating depths of portions of the object for identifying or authenticating the object (e.g., for face authentication). System 200 includes a projector 202 and a receiver 208. Projector 202 may be referred to as a “structured light source”, “transmitter,” “emitter,” “light source,” or other similar term, and should not be limited to a specific transmission component. Throughout the following disclosure, the terms projector, transmitter, and light source may be used interchangeably. Receiver 208 may be referred to as a “detector,” “sensor,” “sensing element,” “photodetector,” and so on, and should not be limited to a specific receiving component.

Projector 202 may be configured to project or transmit a pattern 204 of dots (e.g., light points or shapes) onto scene 206. The white circles in pattern 204 indicate where no light is projected, and the black circles in pattern 204 indicate where light is projected. The disclosure may alternatively refer to the pattern 204 as a codeword distribution or a distribution, where defined portions of the pattern 204 are codewords (also referred to as codes).

Projector 202 includes one or more light sources 224 (such as one or more lasers). In some implementations, the one or more light sources 224 includes a laser array. In one illustrative example, each laser may be a vertical cavity surface emitting laser (VCSEL). In another illustrative example, each laser may include a distributed feedback (DFB) laser. In another illustrative example, the one or more light sources 224 may include a resonant cavity light emitting diodes (RC-LED) array. In some implementations, the projector may also include a lens 226 and a light modulator 228. Projector 202 may also include an aperture 222 from which the transmitted light escapes projector 202. In some implementations, projector 202 may further include a diffractive optical element (DOE) to diffract the emissions from one or more light sources 224 into additional emissions. In some aspects, the light modulator 228 (which may adjust the intensity of the emission) may include a DOE.

In projecting pattern 204 of dots onto scene 206, projector 202 may transmit one or more lasers from light source 224 through lens 226 (and/or through a DOE and/or light modulator 228) and onto objects 206A and 206B in scene 206. Projector 202 may be positioned on the same reference plane as receiver 208, and projector 202 and receiver 208 may be separated by a known distance, which may be referred to as baseline 212.

In some implementations, the light projected by projector 202 may be infrared (IR) light. IR light may include portions of the visible light spectrum and/or portions of the light spectrum that is not visible to the naked eye. In one example, IR light may include near infrared (NIR) light, which may or may not include light within the visible light spectrum, and/or IR light (such as far infrared (FIR) light) which is outside the visible light spectrum. The term IR light should not be limited to light having a specific wavelength in or near the wavelength range of IR light. Further, IR light is provided as an example emission from the projector. In the following description, other suitable wavelengths of light may be used. For example, light in portions of the visible light spectrum outside the IR light wavelength range or ultraviolet (UV) light may be used.

Scene 206 may include objects at different depths from system 200 (such as from projector 202 and receiver 208). For example, objects 206A and 206B in scene 206 may be at different depths. Receiver 208 may be configured to receive, from scene 206, reflections 210 of the transmitted pattern 204 of dots. To receive reflections 210, receiver 208 may capture a frame. When capturing the frame, receiver 208 may receive reflections 210, as well as (i) other reflections of pattern 204 of dots from other portions of scene 206 at different depths, (ii) ambient light, and (iii) noise. In the present disclosure, the terms “frame” and “image” may be used interchangeably to refer to what is captured by receiver 208. In some cases, the frame (or image) may be or may include a visible image. In some cases, the frame (or image) may include intensity values including intensities of reflections 210. The intensity values may be based on reflections 210 of visible light, IR light, or UV light.

In some implementations, receiver 208 may include a lens 230 to focus or direct the received light (including reflections 210 from the objects 206A and 206B) on to a sensor 232 of receiver 208. Receiver 208 also may include an aperture 220. Assuming for the example that only reflections 210 are received, depths of the objects 206A and 206B (e.g., distances between projector 202 or receiver 208 and objects 206A and 206B respectively) may be determined based on baseline 212 and displacement and distortion of dots of pattern 204 in reflections 210.

As noted above, the system 200 can implement a keypoint-matching-based depth-estimation technique. For instance, to compare displacement and distortion, system 200 may match dots (e.g., a group or window of dots 240) of pattern 204 as projected by projector 202 with the dots of the pattern as captured in images at receiver 208.

In some cases, an intensity of reflections 210 may also be used to determine depths of objects 206A and 206B. For example, a distance 234 along sensor 232 from location 216 to a center 214 of sensor 232 may be used in determining a depth of object 206B in scene 206. Similarly, a distance 236 along sensor 232 from a location 218 to center 214 may be used in determining a depth of object 206A in scene 206. The distance along sensor 232 may be measured in terms of number of pixels of sensor 232 or a unit of distance (such as millimeters).

In some implementations, sensor 232 may include an array of photodiodes (such as avalanche photodiodes) for capturing a frame. To capture the frame, each photodiode in the array may capture the light that hits the photodiode and may provide a value indicating the intensity of the light (a capture value). The frame therefore may be an array of capture values provided by the array of photodiodes. In addition or alternative to sensor 232 including an array of photodiodes, sensor 232 may include a complementary metal-oxide semiconductor (CMOS) sensor. To capture the image by a photosensitive CMOS sensor, each pixel of the sensor may capture the light that hits the pixel and may provide a value indicating the intensity of the light. In some example implementations, an array of photodiodes may be coupled to the CMOS sensor. In this manner, the electrical impulses generated by the array of photodiodes may trigger the corresponding pixels of the CMOS sensor to provide capture values.

Sensor 232 may include at least a number of pixels equal to the number of possible dots in pattern 204. For example, the array of photodiodes or the CMOS sensor may include at least a number of photodiodes or a number of pixels, respectively, corresponding to the number of possible dots in pattern 204. In some implementations, sensor 232 may include more pixels than the number of possible dots of pattern 204. For example, in some cases, sensor 232 may include five or ten times as many pixels as pattern 204 includes dots. If light source 224 transmits IR light (such as NIR light at a wavelength of, e.g., 940 nanometers (nm)), sensor 232 may be an IR sensor to receive the reflections of the NIR light.

As illustrated, distance 234 (corresponding to a reflection 210 from object 206B) is less than distance 236 (corresponding to a reflection 210 from object 206A). Using triangulation based on baseline 212 and distance 234 and distance 236, the differing depths of objects 206A and 206B in scene 206 may be determined and a depth map of scene 206 may be generated. Determining the depths may further be based on a displacement or a distortion of pattern 204 in reflections 210.

In some implementations, projector 202 may be configured to project a fixed light distribution, in which case the same distribution of light is used in every instance for active depth sensing. In some implementations, projector 202 may be configured to project a different pattern of light at different times. For example, projector 202 may be configured to project a first pattern of light at a first time and project a second pattern of light at a second time. A resulting depth map of one or more objects in a scene may thus be based on one or more reflections of the first pattern of light and one or more reflections of the second pattern of light.

Although a number of separate components are illustrated in FIG. 2, one or more of the components may be implemented together or include additional functionality. All described components may not be required for system 200, or the functionality of components may be separated into separate components. Additional components not illustrated also may exist. For example, receiver 208 may include a bandpass filter to allow signals having a determined range of wavelengths to pass onto sensor 232 (thus filtering out signals with a wavelength outside of the range). In this manner, some incidental signals (such as ambient light) may be prevented from being received as interference during the captures by sensor 232. The range of the bandpass filter may be centered at the transmission wavelength for projector 202. For example, if projector 202 is configured to transmit NIR light with a wavelength of 940 nm, receiver 208 may include a bandpass filter configured to allow NIR light having wavelengths within a range of, e.g., 920 nm to 960 nm. Therefore, the examples described regarding FIG. 2 is for illustrative purposes.

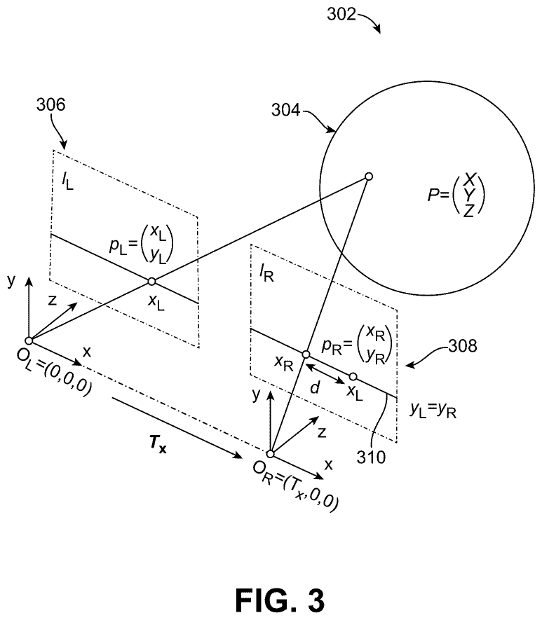

FIG. 3 illustrates two example images, which may be used to determine depth information according to a depth-from-stereo (DFS) depth-estimation technique. DFS depth-estimation may be an example of a keypoint-matching-based depth-estimation technique.

FIG. 3 illustrates image 306 and image 308 (also denoted in FIG. 3 as image I_{L} and image I_{R}), of a single scene 302 captured from different camera positions, according to various aspects of the present disclosure. The different camera positions are marked as left and right “origin” points, O_{L} and O_{R}, which are offset by a distance Tₓ. Because of the offset Tₓ, the same point P of object 304 appears at different pixel locations p_{L} and p_{R} within the two images 306 (I_{L}) and 308 (I_{R}). As can be seen, the x-axis coordinate x_{R} in image 308 (I_{R}), corresponding to point P_{R} in image 308 (I_{R}), is offset along epi-polar line 310 by disparity d from a coordinate x_{L}, where the coordinate x_{L} corresponds to the position of the point P in the image 306 (I_{L}). This disparity in pixel locations (also referred to as discrepancy) may be used to determine an approximate distance from the cameras to the point P on object 304 in scene 302. By knowing the stereo camera geometry and applying such an analysis to each point in the images, a depth map of the scene may be generated.

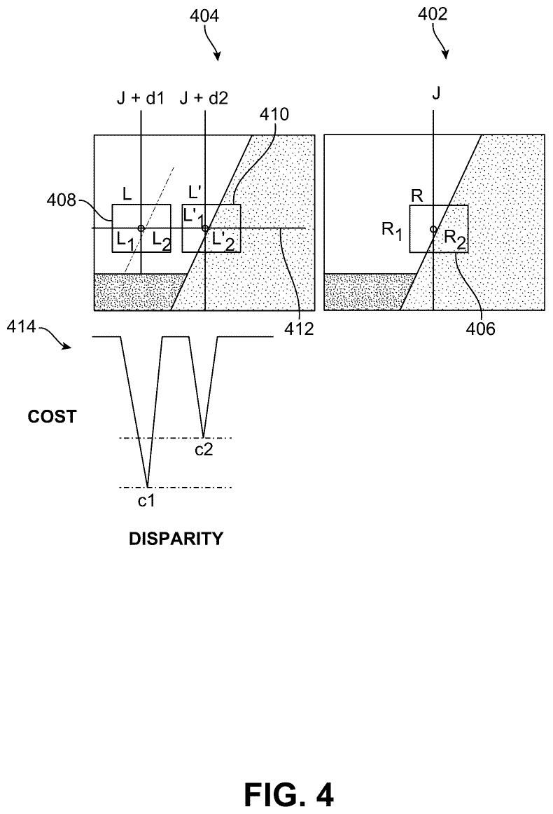

In order to determine the disparity d, a system may determine that the pixel location p_{R} in the image 308 (I_{R}) corresponds to the pixel location p_{L} in the image 306 (I_{L}), for example, by comparing a window of pixels including pixels at, and around, the pixel location p_{L} to a number of windows of pixels in image 308 (I_{R}). An example of such a window-based comparison technique is described with respect to FIG. 4. For example, a passive stereo-vision system may determine epi-polar line 310 in the image 308 (I_{R}). Epi-polar line 310 may be a defined by a ray projected from origin point O_{L} to the point P as viewed in in the image 306 (I_{R}). The passive stereo-vision system may compare the window of pixels including pixels at, and around, the pixel location p_{L} to similarly-sized windows along epi-polar line 310.

FIG. 4 illustrates two example images, image 402 (which may be a “right image” or a “reference image”) and image 404 (which may be a “left image”), and an example associated cost function 414, according to various aspects of the present disclosure. To compare windows between image 402 and image 404, a window 406 of pixels from the image 402 may be selected. Window 406 of pixels from image 402 may be compared to one or more windows of pixels from image 404. In some cases, window 406 may be compared to similarly-sized windows (e.g., all similarly-sized windows) along an epi-polar line 412 of image 404.

The cost function 414 shown in FIG. 4 is representative of a similarity between window 406 and similarly-sized windows along epi-polar line 412 of image 404 as a function of disparity. The similarity between windows may be based on similarities between respective red, green, blue, and/or intensity (or brightness or luminance) values of pixels included in the respective windows. The lower the value of cost function 414 for a particular disparity, the higher the degree of similarity is between window 406 and a window of image 402 at the corresponding disparity. For example, cost function 414 includes two minima, c1 and c2. The minima c1 corresponds to a disparity d1, which corresponds to a comparison between window 406 and candidate window 408 of image 404. The minima c2 corresponds to a disparity d2 which corresponds to a comparison between window 406 and candidate window 410 of image 404.

A disparity map may be a two-dimensional map of disparities. The two-dimensional map may relate to an image (e.g., image 306 of FIG. 3). For instance, a two-dimensional disparity map may include a resolution that is the same (or substantially the same in some cases) as a corresponding image, with a respective disparity value for each pixel of the image. In one illustrative example, a disparity map may be generated by determining a respective disparity for each pixel of a number of pixels (e.g., all, or most, of the pixels) of an image (e.g., by scanning windows across epi-polar lines of a stereoscopically-paired image and determining a disparity for each of the number of pixels). Each value of the disparity map may represent a disparity (e.g., disparity d of FIG. 3). A depth map may be derived from a disparity map based on the three-dimensional geometry of a scene (e.g., scene 302 of FIG. 3) including a distance between the cameras which captured the images (e.g., the distance Tₓ of FIG. 3).

A depth map may be a representation of three-dimensional information (e.g., depth information). For example, a depth map may be a two-dimensional map of values (e.g., pixel values) representing depths. The values of the depth map may correspond to pixels in a corresponding image (e.g., image 306 of FIG. 3). For instance, the depth map may have a resolution that is the same or substantially the same as the corresponding image, with each depth value of the depth map representing a depth, or distance, between an origin point (e.g., origin point O_{L} of FIG. 3) and points (e.g., point P of FIG. 3). In some cases, each pixel in the depth map may have one depth value. Because a depth map is based on a disparity map, in some cases, each pixel of a disparity may have one disparity.

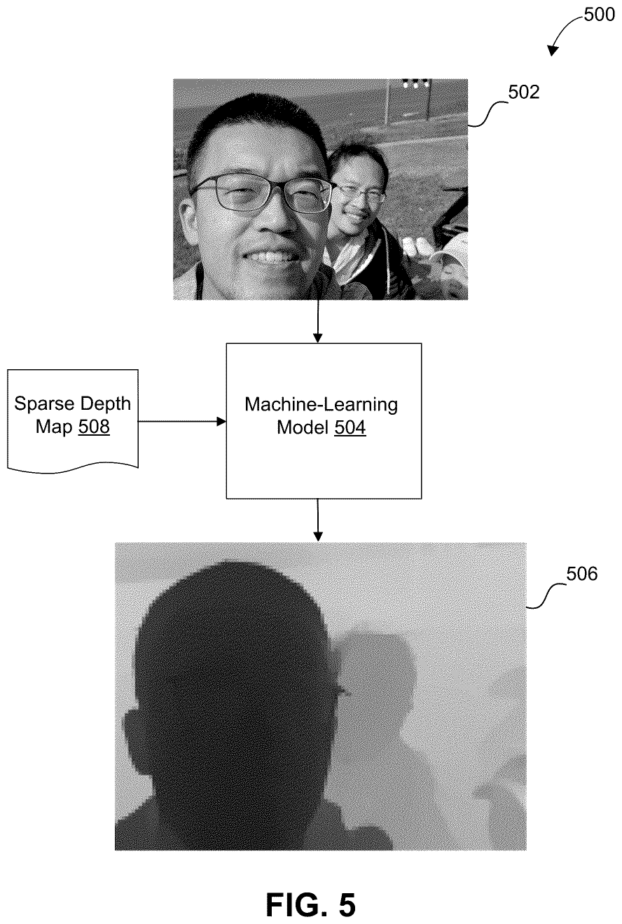

FIG. 5 is a block diagram illustrating an example system 500 that implements a machine-learning-based depth-estimation technique, according to various aspects of the present disclosure. For example, machine-learning model 504 may take image 502 as an input and generate depth map 506.

Depth map 506 may include a number of depth values for a number of depth pixels. Depth map 506 is illustrated in FIG. 5 with grayscale representations of depth values. For example, dark points of depth map 506 may represent depth pixels with close depth values and light points of depth map 506 may represent depth pixels with distant depth values.

Machine-learning model 504 may be trained to generate depth maps based on images through a backpropagation training process. For example, a corpus of training data may be obtained. The corpus of training data may include a number of training images and a corresponding number of training depth maps (which may be used as “ground truth” during the training process). The training depth maps may be determined according to one of the other methods described herein. During the training process, machine-learning model 504 may be provided with a training image. Machine-learning model 504 may generate a provisional depth map based on the training image. The provisional depth map may be compared to the training depth map that corresponds to the training image. Differences (e.g., “errors”) between provisional depth map and the training depth map may be determined. Parameters (e.g., weights) of machine-learning model 504 may be adjusted based on the differences to decreases differences in future iterations of the training process (e.g., according to a gradient descent technique). After a number of iterations of the training process, machine-learning model 504 may be deployed in system 500.

In some aspects, machine-learning model 504 may also receive sparse depth map 508 as an input and generate depth map 506 based on image 502 and sparse depth map 508. Sparse depth map 508 may be a depth map generated using a projection-based depth-estimation technique. Sparse depth map 508 may be sparse, for example, including fewer depth pixels than can accurately represent a scene. For example, image 502 may include one million image pixels and image values. In contrast, sparse depth map 508 may include one hundred depth values (e.g., based on a projection-based depth-estimation technique projecting one hundred light pulses). Machine-learning model 504 may be trained to generate depth map 506 based on images and depth maps.

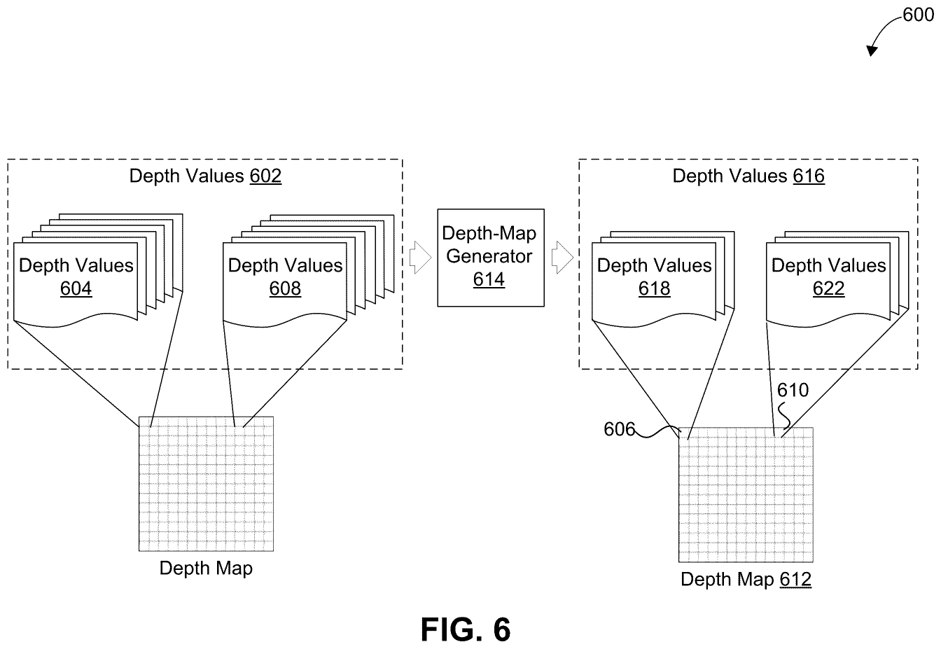

FIG. 6 is a block diagram illustrating an example system 600 for storing depth information, according to various aspects of the present disclosure. In general, depth-map generator 614 may obtain multiple depth values 602. Depth values 602 may include a number of depth values for each depth pixel of a depth map. Depth-map generator 614 may determine depth values 616 based on depth values 602. Depth values 616 may include three (or more) depth values for each depth pixel of a depth map 612. Depth-map generator 614 may store the three (or more) depth values for each depth pixel of depth map 612.

Depth values 604 are provided as an example of depth values 602 that correspond to a depth pixel of a depth map. For example, depth values 604 correspond to depth pixel 606 of depth map 612. Depth values 608 are provided as an example of other depth values that correspond to another depth pixel of the depth map. For example, depth values 608 correspond to depth pixel 610 of depth map 612. Depth-map generator 614 may not obtain depth map 612 as an input but may generate depth map 612 as an output. Thus, depth values 602 may be for depth pixels of depth map 612 which may be generated by depth-map generator 614.

Depth-map generator 614 may receive depth values 602 but not depth map 612. For example, depth values 602 may include depth values for specific depth pixels of a depth map, however, the depth map itself may not, at least initially, exist. For example, depth values 602 may include a number of depth values of a number of separate respective depth maps. As such, each of depth values 602 may be of a separate depth map and no single depth map may include all of depth values 602. In such cases, depth-map generator 614 may receive depth values 602 as individual depth values. Additionally or alternatively, depth-map generator 614 may receive the number of depth maps, each of the number of depth maps including depth value corresponding to each depth pixel of depth map 612.

As another example, depth values 602 may be, or may include, a number of depth-measurement values corresponding to a particular depth pixel of a depth sensor. However, the depth sensor may, or may not, generate a depth map including the depth values. For instance, depth values 602 may include depth values 602 may include a number of depth-measurement values generated by individual depth sensors of an array depth sensors of receiver 104 of FIG. 1.

As another example, depth values 602 may be, or may include, a number of depth-estimate values corresponding to a particular group of pixels of an image. For instance, depth values 604 may be based a group of pixels of an image captured by receiver 208 of FIG. 2, a group of pixels of image 306 of FIG. 3, or a group of pixels of image 502 of FIG. 5. In such cases, depth-map generator 614 may receive depth values 602 as individual depth values. Depth values 602 may yet correspond to depth pixels of depth map 612 based on the location of the pixels in the image or images. For example, a depth sensor may provide a stream of depth values as they are generated and pixel coordinates on which the depth values were based. Additionally or alternatively, the depth sensor may generate depth maps and provide the depth maps to depth-map generator 614.

As an example of depth values 602, system 100 of FIG. 1 may generate multiple (e.g., tens or hundreds) of depth values for each depth pixel of a depth map (e.g., based on receiver 104 including an array of depth sensors or based on receiver 104 scanning the scene). For example, based on a pulsing frequency of projector 102 pulsing emitted light pulse 106, system 100 may store tens or hundreds of depth values per depth pixel per second. For instance, system 100 may generate tens or hundreds of instances of depth values 604 for depth pixel 606 and tens or hundreds of instances of depth values 608 for depth pixel 610 each second.

Similarly, system 200 of FIG. 2 may generate multiple (e.g., tens) of depth values for each depth pixel of a depth map. For example, based on a frame capture rate of receiver 208, system 200 may capture tens of images of scene 206 per second and generate tens of depth values per depth pixel per second (based on a resolution of the images and of pattern 204). For instance, system 200 may generate tens of instances of depth values 604 for depth pixel 606 and tens of instances of depth values 608 for depth pixel 610.

Similarly, a depth-from-stereo (DFS) system generating depth values based on the keypoint-matching-based depth-estimation techniques illustrated in FIG. 3 and FIG. 4 may generate multiple (e.g., tens) of depth values for each depth pixel of a depth map. For example, based on a frame capture rate of a camera capturing images, the DFS system may capture tens of images per second and generate tens of depth values per depth pixel per second. For instance, a DFS system may generate tens of instances of depth values 604 for depth pixel 606 and tens of instances of depth values 608 for depth pixel 610.

Machine-learning model 504 of FIG. 5 may be trained to generate multiple depth values and/or to generate confidence values for depth values. For example, machine-learning model 504 may generate a confidence value for each depth value of depth map 506. In some cases, machine-learning model 504 may generate multiple depth values and/or confidence values for each depth pixel based on each image 502. Additionally or alternatively, machine-learning model 504 may generate multiple depth values and/or confidence values for each depth pixel each time a new image is captured (e.g., as a frame-capture rate of a camera).

Depth-map generator 614 may generate depth values 616 based on depth values 602. Depth values 616 may include three (or more) depth values for each depth pixel of depth map 612. Depth-map generator 614 may generate depth map 612 to include three (or more) depth values for each depth pixel of depth map 612. For example, depth map 612 may include depth values 618 (including three or more depth values) corresponding to depth pixel 606 and depth values 622 (including three or more depth values) corresponding to depth pixel 610.

In some cases, depth-map generator 614 may select three (or more) depth values from among depth values 602 for each depth pixel of depth map 612. For example, depth-map generator 614 may select three (or more) of depth values 604 as depth values 618 and three (or more) of depth values 608 as depth values 622. In some cases, depth-map generator 614 may generate three (or more) depth values for each depth pixel of depth map 612 based on depth values 602. For example, depth-map generator 614 may generate depth values 618 based on a statistical measure of depth values 604 and depth values 622 based on a statistical measure of depth values 608.

Depth-map generator 614 may select or generate depth values 616 such that depth values 616 represent statistical measures of depth values 602 on a per-depth-pixel basis. For example, depth-map generator 614 may generate depth values 616 (or select depth values 616 from among depth values 602) for each depth pixel of depth map 612 to represent a statistical measure of depth values of depth pixels of depth values 602.

For example, depth values 616 may represent confidence intervals for depth pixels of depth map 612 based on depth values 602. For instance, depth values 618 may represent a confidence interval for depth pixel 606 (e.g., based on depth values 604) and depth values 622 may represent a confidence interval for depth pixel 610 (e.g., based on depth values 608). For instance, depth values 618 may include a first depth value (e.g., a low depth value) and a second depth value (e.g., a high depth value). The first depth value and the second depth value may represent the bounds of a confidence interval for the depth values of depth pixel 606. For example, 80% or 90% of depth values 604 may be between the low depth value and the high depth value of depth values 618.

Additionally or alternatively, depth-map generator 614 may generate depth values 616 (or select depth values 616 from among depth values 602) to represent (on a per-depth-pixel basis) a median of depth values 602, an average of depth values 602, a mode of depth values 602, or a likely depth value of depth values 602 for each depth pixel of depth map 612. For example, in addition to the low and high depth values, depth values 616 may include a third depth value for each depth pixel of depth map 612. The third depth values may represent an average of the depth values, a median of the depth values, a mode of the depth values, or a likely depth values for that depth pixels. For example, depth values 618 may include a depth value representative of an average, a median, a mode, or a likely depth value of depth pixel 606 based on depth values 604.

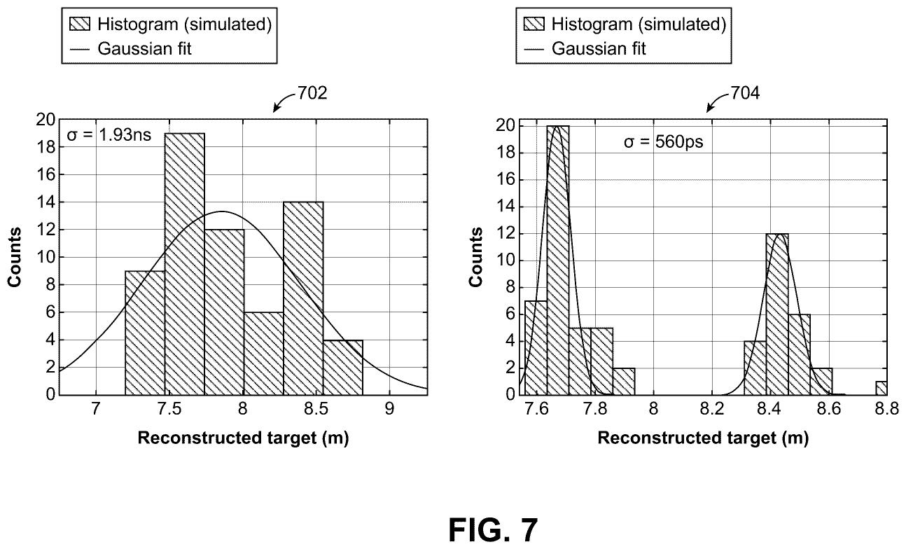

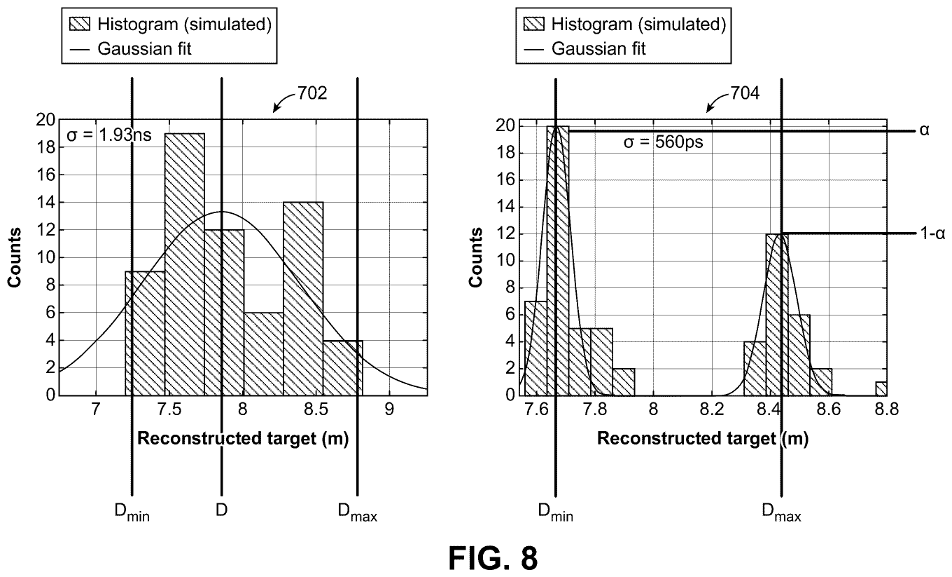

Depth values 616 representing a confidence interval and another statistical measure may represent well cases in which a distribution profile of depth values of a depth pixel exhibit a single-peak distribution profile (e.g., a gaussian distribution around a mean value). For example, FIG. 7 includes histogram 702 which illustrates an example distribution profile of depth values corresponding to a single depth pixel. For example, histogram 702 may be a distribution profile of depth values 604. Histogram 702 is an example of a single-peak distribution profile, for example, histogram 702 may be well fit by a single-peak gaussian. Histogram 702 may be well represented by a confidence interval and a median value. For example, FIG. 8 includes histogram 702 and additional lines to illustrate a first depth value (e.g., a low depth value) Dₘᵢₙ, a second depth value (e.g., a high depth value) Dₘₐₓ, and a third depth value D. Dₘᵢₙ and Dₘₐₓ may represent the bounds of a confidence interval. For example, 90% of the values represented by histogram 702 may fall between Dₘᵢₙ and Dₘₐₓ. D may represent a median depth value of the depth values represented by histogram 702.

However, depth pixels with depth values that exhibit a multi-peak distribution profile may be better represented by other statistical measures. For example, for a depth pixel with depth values that exhibit a multi-peak distribution profile, statistical measures relating to two or more of the multiple peaks in the distribution profile may better represent the depth values. For example, FIG. 7 includes histogram 704 which illustrates an example distribution profile of depth values corresponding to a single depth pixel. For example, histogram 704 may be a distribution profile of depth values 608. Histogram 704 exhibits a multi-peak distribution profile, for example, histogram 704 may be well fit by two gaussian peaks. Histogram 704 may not be well represented by a confidence interval and a median value. Histogram 704 may be better represented by a median, mode, or average depth value representative of each of the peaks of histogram 704. For example, FIG. 8 includes histogram 704 and additional lines to illustrate a first depth value (e.g., a low depth value) Dₘᵢₙ, a second depth value (e.g., a high depth value) Dₘₐₓ, and a third value α. Dₘᵢₙ may represent a median of a lower of the two peaks of histogram 704 and Dₘₐₓ may represent the median of the higher of the two peaks of histogram 704. α may be based on a count of a mode of the more prominent of the two peaks of histogram 704. For example, a mode of the leftmost peak of histogram 704 may include 20 values and a mode of the rightmost peak of histogram 704 may include 12 values. Accordingly, α may be 20/32 (e.g., a count of the mode of the leftmost peak divided by a sum of the count of the mode of the leftmost peak and a count of the mode of the rightmost peak). A leftmost peak of a histogram may indicate a depth of a foreground of a scene and a rightmost peak of a histogram may indicate a depth of a background of a scene.

Returning to FIG. 6, depth-map generator 614 may determine whether depth values related to each depth pixel of depth map 612 exhibit a multi-peak distribution profile or a single-peak distribution profile. For each depth pixel of depth map 612 that includes depth values that exhibit a multi-peak distribution profile, depth-map generator 614 may determine depth values 618 to include a depth value representing an average depth value, a median depth value, a mode depth value, of each peak in the multi-peak distribution profile. For example, if depth values 608 exhibits a multi-peak distribution profile, depth values 622 may include an average, median, or mode depth value for each peak in the multi-peak distribution profile.

In some cases, the number of depth values for each depth pixel of depth values 616 may be selected to be the same. For example, depth values 616 may include three depth values for each depth pixel of depth map 612. In such cases (and/or to manage a size of depth values 616), for depth values that exhibit a multi-peak distribution profile, only a selected number of the peaks in the multi-peak distribution profile may be explicitly represented by depth values 616. For example, if depth values 616 includes three depth values for each depth pixel of depth map 612, and depth values 608 exhibits three or more peaks in its multi-peak distribution profile, depth-map generator 614 may generate depth values 618 to include a median of each of the largest or most prominent two peaks of the multi-peak distribution profile.

Additionally or alternatively, for a depth pixel that relates to depth values that exhibits a multi-peak distribution profile (and/or, in some cases, for a depth pixel that relates to depth values that exhibits a single-peak distribution profile), depth values 616 may include a depth value (or depth values) based on to one or more of: a reflectivity of a point in a scene corresponding to the depth pixel, an opacity of the point in the scene corresponding to the depth pixel, a pixel coverage between a foreground and a background, a count of a mode of depth values of the depth information corresponding to the depth pixel, or a confidence related to one or both of the first depth value and the second depth value. For example, if depth values 608 exhibit a multi-peak distribution profile, depth values 622 may include a median depth value for the two most prominent peaks of the multi-peak distribution profile. Further, depth values 622 may include a third depth value based on a reflectivity of a point in a scene corresponding to the depth pixel, an opacity of the point in the scene corresponding to the depth pixel, a pixel coverage between a foreground and a background, a count of a mode of depth values of the depth information corresponding to the depth pixel, or a confidence related to one or both of the first depth value and the second depth value.

Reflectivity and/or opacity can be determined, in the case of projection-based depth-estimation techniques, based on a ratio between the signal strength of the first return and the strength of the second return. For triangulation-based depth-estimation techniques, like depth from stereo and structured light, the first and second depths may be detected based on the first and second image feature correlations (keypoint matching) between the two images. The relative strength of the first and second correlations can be a proxy for reflectivity/opacity.

Pixel coverage may relate to a relationship between foreground points in a scene and background points in the scene represented by the same depth pixel. For example, a depth pixel may represent several points in a scene (e.g., based on a size of the depth pixel). Depth values from such a depth pixel may include a foreground depth, a background depth, and an indication of a relationship between the two. For example, a foreground element may account for 40% of a depth pixel's area, and a background element account for 60% of the depth pixel's area. The pixel's depth values may be (depth_FG, depth_BG, 0.6).

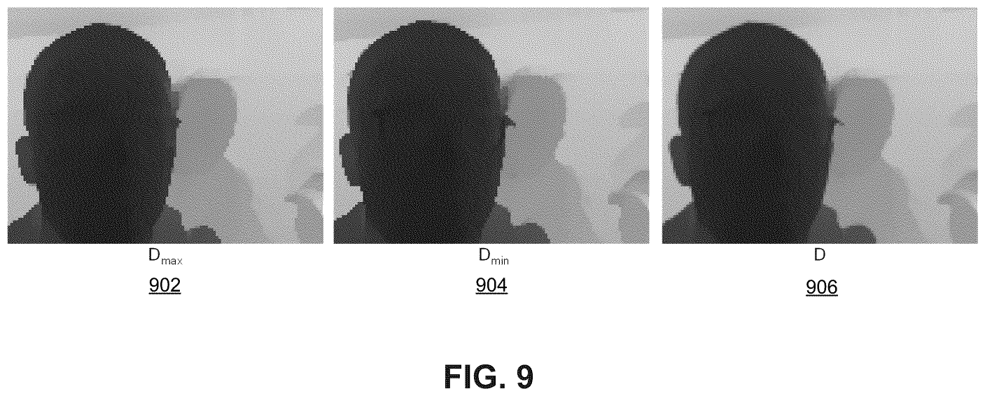

FIG. 9 includes three representations of depth values, according to various aspects of the present disclosure. The depth values are illustrated in FIG. 9 as a grayscale representations of depth values. For example, dark points may represent depth pixels with close depth values and light points may represent depth pixels with distant depth values.

FIG. 9 includes a first number of depth values (first depth values 902) arranged together to form a first depth map, a second number of depth values (second depth values 904) arranged together to form a second depth map, and a third number of depth values (third depth values 906) arranged together to form a third depth map.

Collectively, first depth values 902, second depth values 904, and third depth values 906 may be an example of depth values 616 of FIG. 6. Additionally or alternatively, collectively, first depth values 902, second depth values 904, and third depth values 906 may be an example of depth map 612 of FIG. 6. For example, a given depth pixel of depth map 612 may include a depth value of first depth values 902, a depth value of second depth values 904 and a depth value of third depth values 906.

First depth values 902 may represent high depth values of each depth pixel of a depth map. For example, first depth values 902 may represent the distant end of the confidence intervals of each depth pixel of depth map 612. Second depth values 904 may represent low depth values of each depth pixel of a depth map. For example, second depth values 904 may represent the close end of the confidence intervals of each depth pixel of depth map 612. Third depth values 906 may represent an average, a median, or a mode of depth values. For example, third depth values 906 may represent an average of depth values 602 for each depth pixel of depth map 612.

As mentioned with regard to FIG. 6, depth-map generator 614 may determine whether each depth pixel of depth map 612 relates to depth values that exhibit a single-peak distribution profile or a multi-peak distribution profile. Depth-map generator 614 may then determine depth values for each depth pixel of depth map 612 based on whether the respective depth pixel relates to depth values that exhibit a single-peak distribution profile or a multi-peak distribution profile. In the example of FIG. 9, first depth values 902, second depth values 904, and third depth values 906 all include depth values selected as if first depth values 902, second depth values 904, and third depth values 906 were related to depth values that exhibited a single-peak distribution profile. For example, in the example of FIG. 9, first depth values 902 and second depth values 904 collectively may be depth values of a depth map made up entirely of depth values describing a depth interval and third depth values 906 may represent a statistical measure.

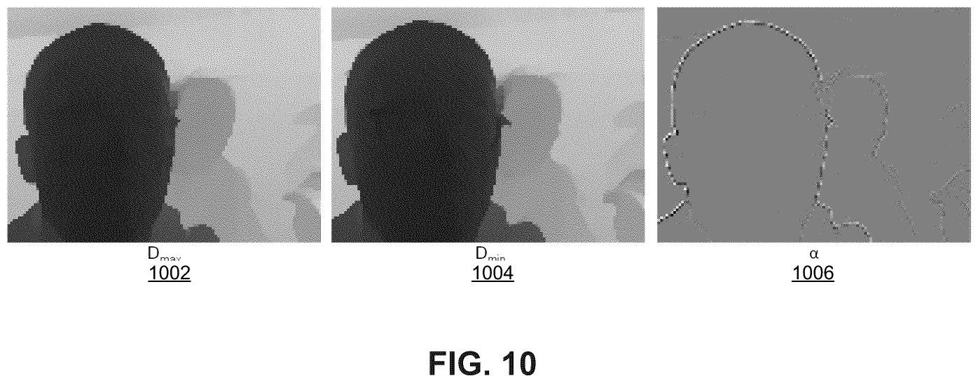

FIG. 10 includes three representations of depth values, according to various aspects of the present disclosure. The depth values are illustrated in FIG. 10 as a grayscale representations of depth values. For example, dark points may represent depth pixels with close depth values and light points may represent depth pixels with distant depth values.

FIG. 10 includes a first number of depth values (first depth values 1002) arranged together to form a first depth map, a second number of depth values (second depth values 1004) arranged together to form a second depth map, and a third number of depth values (third depth values 1006) arranged together to form a third depth map.

Collectively, first depth values 1002, second depth values 1004, and third depth values 1006 may be an example of depth values 616 of FIG. 6. Additionally or alternatively, collectively, first depth values 1002, second depth values 1004, and third depth values 1006 may be an example of depth map 612 of FIG. 6. For example, a given depth pixel of depth map 612 may include a depth value of first depth values 1002, a depth value of second depth values 1004 and a depth value of third depth values 1006.

First depth values 1002 may represent a distant peak of a multi-peak distribution profile of depth values. For example, first depth values 1002 may represent a Dₘₐₓ values of multi-peak distribution profiles of each depth pixel of a depth map. Second depth values 1004 may represent a close peak of a multi-peak distribution profile of depth values. For example, second depth values 1004 may represent a Dₘᵢₙ values of multi-peak distribution profiles of each depth pixel of a depth map. Third depth values 1006 may represent a of multi-peak distribution profile of depth values. For example, third depth values 1006 may represent a α values of multi-peak distribution profiles of each depth pixel of a depth map. α may be based on a normalized ratio of the counts of depth values of a mode of peaks of the multi-peak distribution profile.

As mentioned with regard to FIG. 6, depth-map generator 614 may determine whether each depth pixel of depth map 612 relates to depth values that exhibit a single-peak distribution profile or a multi-peak distribution profile. Depth-map generator 614 may then determine depth values for each depth pixel of depth map 612 based on whether the respective depth pixel relates to depth values that exhibit a single-peak distribution profile or a multi-peak distribution profile. In the example of FIG. 10, first depth values 1002, second depth values 1004, and third depth values 1006 all include depth values selected as if first depth values 1002, second depth values 1004, and third depth values 1006 were related to depth values that exhibited a multi-peak distribution profile. For example, in the example of FIG. 10, first depth values 1002 may represent distant peaks of depth values of each depth pixel of a depth map and second depth values 1004 may represent close peaks of depth values of each depth pixel of the depth map. In cases in which the depth values represent a glass window and objects behind the window, first depth values 1002 may represent objects behind the window and second depth values 1004 may represent the glass window. Third depth values 1006 may be based on the ratio between the modes of first depth values 1002 and second depth values 1004 for each depth pixel.

If depth-map generator 614 of FIG. 6, where to determine whether each depth pixel of depth map 612 relates to depth values that exhibit a single-peak distribution profile or a multi-peak distribution profile and generate each pixel of depth values 616 independently based on the determination, the result would be a combination of the depth values illustrated by FIG. 9 and FIG. 10. In particular, some of the depth pixels may include depth values that represent confidence intervals (e.g., as described with regard to first depth values 902 and second depth values 904) and other may include depth values that represent close and distant depth values (e.g., as described with regard to first depth values 1002 and second depth values 1004).

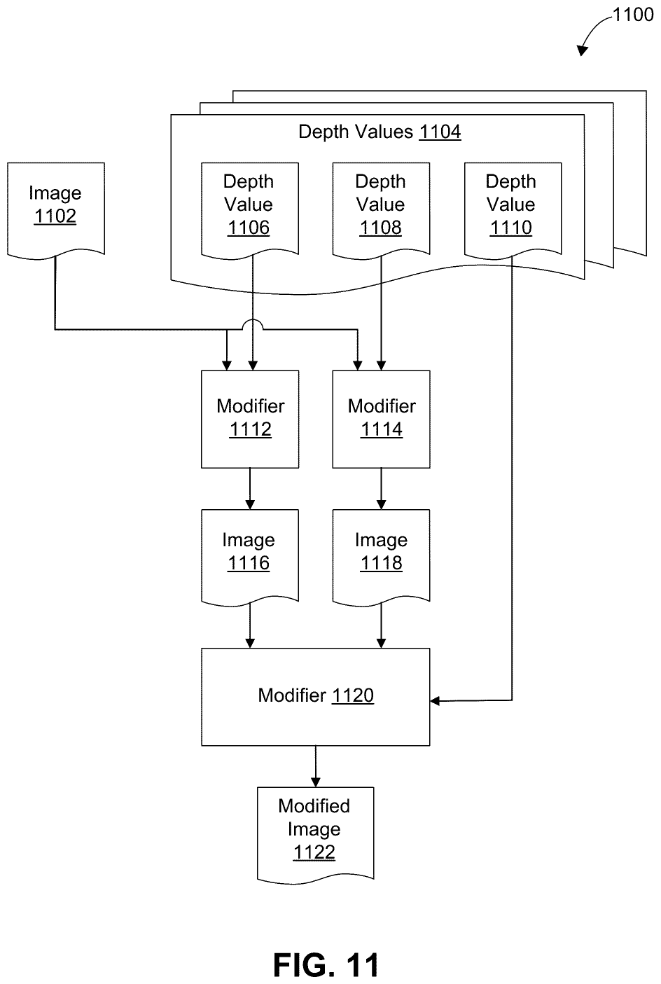

FIG. 11 is a block diagram illustrating an example system 1100 for modifying an image 1102 based on depth values 1104, according to various aspects of the present disclosure. For example, system 1100 may obtain image 1102 and modify image 1102 based on depth values 1104 to generate modified image 1122. For example, system 1100 may implement a distance-based blurring of image 1102 (e.g., implementing a synthetic Bokeh process).

Image 1102 may include an image captured by an image sensor. Image 1102 may be a color image including, for example, red, green, and blue pixel values.

Depth values 1104 may be, or may include, a depth map including three (or more) depth values for each depth pixel of the depth map. Depth values 1104 may be an example of depth values 616 of FIG. 6. Depth value 1106 may be an example depth value of a given depth pixel. Depth value 1108 may be an example of another depth value of the given depth pixel and depth value 1110 may be an example of a third depth value of the given depth pixel. For example, depth value 1106 and depth value 1108 may represent a confidence interval for depth values of the depth pixel and depth value 1110 may represent a statistical measure of the depth values of the depth pixel. Alternatively, depth value 1106 may represent a mode of depth values of a close depth peak of a multi-peak distribution profile, depth value 1108 may represent a mode of depth values of a distant depth peak of a multi-peak distribution profile, and depth value 1110 may represent a ratio of a count of the two modes. In either case, depth value 1106 may relate to close depth values (e.g., a close end of a confidence interval or a close peak of a multi-peak distribution profile) and depth value 1108 may relate to distant depth values (e.g., a distant end of a confidence interval or a distant peak of the multi-peak distribution profile). Depth values 1104 may include three or more depth values for each depth pixel of a depth map. For some of the depth pixels, depth values 1104 may include depth values representing a confidence interval and for others depth values 1104 may include depth values representing peaks of a multi-peak distribution profile.

Modifier 1112 may modify image 1102 based on depth value 1106 to generate image 1116. For example, modifier 1112 may implement a distance-based blurring of image 1102 based on depth value 1106. Similarly, modifier 1114 may modify image 1102 based on depth value 1108 to generate image 1118. For example, modifier 1114 may implement a distance-based blurring of image 1102 based on depth value 1108.

Modifier 1120 may combine image 1116 and image 1118 to generate modified image 1122. For example, modifier 1120 may blend image 1116 and image 1118. In some cases, modifier 1120 may blend image 1116 and image 1118 based on depth value 1110. For example, modifier 1120 may represent a-a ratio between peaks of a multi-peak distribution profile. Modifier 1120 implement a blending on image 1116 and image 1118.

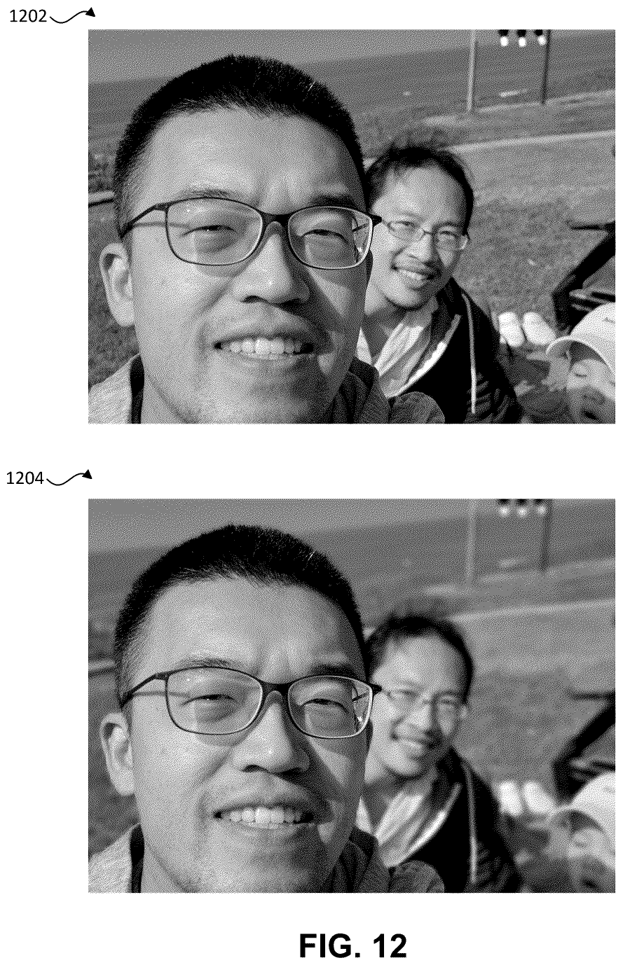

FIG. 12 includes an example image 1202 and an example modified image 1204, according to various aspects of the present disclosure. Image 1202 may be an example of image 1102 of FIG. 11 and modified image 1204 may be an example of modified image 1122 of FIG. 11. For example, image 1202 may be modified by system 1100 of FIG. 11 to generate modified image 1204. As such, modified image 1204 may exhibit depth-based blurring. For example, background objects may be blurred whereas foreground objects may not be blurred.

Modified image 1204 may be better than images modified according to other depth-based image modification techniques. For example, because modified image 1204 may be modified based on close depth values and distant depth values (e.g., depth value 1106 and depth value 1108), image pixels of modified image 1204 may more closely correlate with appropriate depth values. For example, pixels may be modified based on a confidence interval and/or based on peaks of a multi-peak distribution profile rather than based only on the depth values themselves.

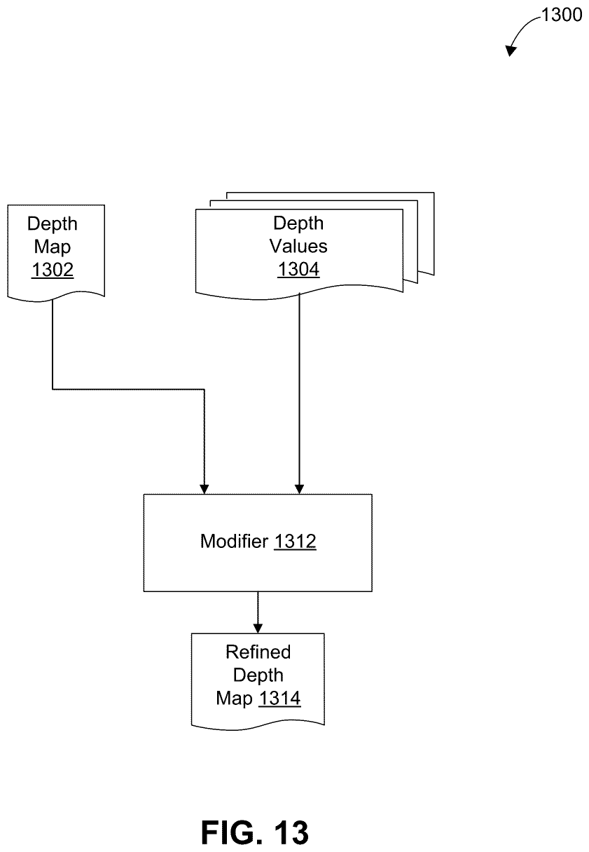

FIG. 13 is a block diagram illustrating an example system 1300 for refining a depth map 1302 based on depth values 1304 or for generating a refined depth map 1314 based on depth values 1304, according to various aspects of the present disclosure. For example, system 1300 may obtain depth map 1302 and modify depth map 1302 based on depth values 1304 to generate refined depth map 1314. For example, system 1300 may smooth or otherwise correct depth map 1302, and/or add depth values (e.g., to add density to a sparse depth map). Additionally or alternatively, system 1300 may generate refined depth map 1314 based on depth values 1304.

Depth map 1302 may be captured according to a projection-based depth-estimation technique, as determined by a keypoint-matching-based depth-estimation technique, and/or as determined by a machine-learning-based depth-estimation technique. Depth map 1302 may include holes (e.g., depth pixels without depth values). Additionally or alternatively, depth map 1302 may include pixels with bad depth values (e.g., depth values based on a multi-path reflection or noise). Additionally or alternatively, depth map 1302 may be sparse. For example, depth map 1302 may include relatively few depth values and system 1300 may add depth values to cause refined depth map 1314 to be denser than depth map 1302.

Depth values 1304 may be, or may include, a depth map including three (or more) depth values for each depth pixel of the depth map. Depth values 1304 may be an example of depth values 616 of FIG. 6. For some of the depth pixels, depth values 1304 may include depth values representing a confidence interval and for others depth values 1304 may include depth values representing peaks of a multi-peak distribution profile.

Modifier 1312 may modify depth map 1302 based on depth values 1304 to generate refined depth map 1314. Alternatively, in some aspects, modifier 1312 may generate refined depth map 1314 based on depth values 1304 without receiving or using depth map 1302. For example, depth map 1302 may be omitted in system 1300.

In some aspects, modifier 1312 may apply an active filter to depth map 1302 (or to depth values 1304) to generate refined depth map 1314. For example, modifier 1312 may apply a bilateral filter to depth map 1302 (or depth values 1304). The bilateral filter may filter the depth values (of depth map 1302 or depth values 1304) based on distance and variance.

For example, modifier 1312 may select a window of depth pixels around a center depth pixel and apply an active filter to the window of depth pixels to determine a new depth value for the center depth pixel of the window. The active filter may determine the new depth value based on depth values of the depth pixels within the window. The active filter may determine the new depth value for the center depth pixel based on a distance between the center depth pixel and each depth pixel of the window of depth pixels and further based on a variance of each depth pixel of the window of depth pixels.

For example, modifier 1312 may apply an active filter that may refine depth values D according to:

$${refine [ D ]}_{p} = \frac{1}{{W}_{p}} {\sum }_{q ∈ S} {G}_{σ} ( ‖ p - q ‖ ) \frac{1}{1 + {Var}_{q}} {D}_{q}$$

where: D represents depth values of a depth map;
p represents a pixel that is being refined (e.g., a center pixel of a window);
q represents a neighboring pixel, (e.g., a pixel of the window);
S represents the number of neighboring pixels;

$$\frac{1}{{W}_{p}} \sum q ∈ S$$

represents a normalization factor;
G_{σ}(∥p−q∥) represents a spatial weight; and

$$\frac{1}{1 + {Var}_{q}}$$

represents a variance weight.

Where the variance weight is approximated by:

$${Var}_{q} = {( \frac{{D}_{max , q} - {D}_{min , q}}{2} )}^{2}$$

Further, modifier 1312 may blend the refined depth values with the original depth values according to:

$${D}_{p} ← {D}_{p} \times \frac{1}{1 + {Var}_{p}} + {refine [ D ]}_{p} \times ( 1 - \frac{1}{1 + {Var}_{p}} )$$

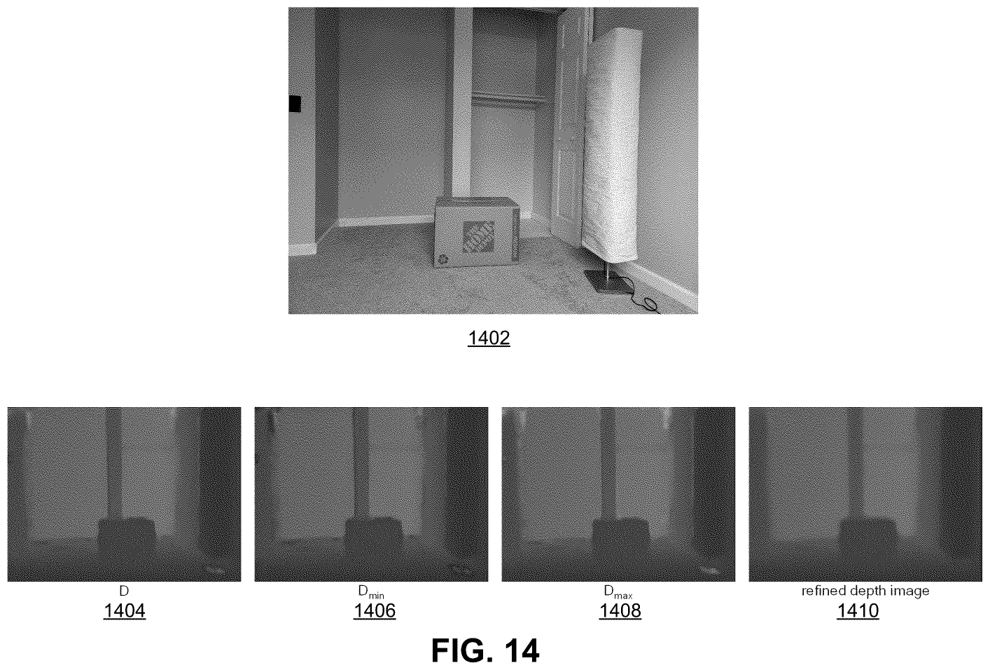

FIG. 14 includes an example image 1402 and four example depth maps corresponding to image 1402. FIG. 14 illustrates results of a depth refining process, according to various aspects of the present disclosure. The depth values are illustrated in FIG. 14 as a grayscale representations of depth values. For example, dark points may represent depth pixels with close depth values and light points may represent depth pixels with distant depth values. Image 1402 is a grayscale image of a scene as captured by a camera. In practice, image 1402 may be a color image.

FIG. 14 includes a first number of depth values (first depth values 1404) which may be captured or determined as representing depths within the scene. First depth values 1404 are arranged together to form a first depth map. First depth values 1404 may represent depth values as captured according to a projection-based depth-estimation technique, as determined by a keypoint-matching-based depth-estimation technique, and/or as determined by a machine-learning-based depth-estimation technique. First depth values 1404 may be an example of depth map 1302 of FIG. 13. Depth values 1304 may include depth holes and/or bad depth values.

FIG. 14 also includes a second number of depth values (second depth values 1406) arranged together to form a second depth map and a third number of depth values (third depth values 1408) arranged together to form a third depth map. Collectively, second depth values 1406 and third depth values 1408 may be an example of depth values 616 of FIG. 6. Additionally or alternatively, collectively, second depth values 1406 and third depth values 1408 may be an example of depth map 612 of FIG. 6. For example, a given depth pixel of depth map 612 may include a depth value of second depth values 1406 and a depth value of third depth values 1408. Second depth values 1406 and third depth values 1408 may be based on a single-peak distribution profile, a multi-peak distribution profile, or a combination of both. For example, second depth values 1406 and third depth values 1408 may be representative of a confidence interval of depth values. As another example, second depth values 1406 and third depth values 1408 may be representative of close and distant peaks of a multi-peak distribution profile. As another example, some of second depth values 1406 and third depth values 1408 may be representative of a confidence interval and others of second depth values 1406 and third depth values 1408 may be representative of close and distant peaks of the multi-peak distribution profile.

FIG. 14 also includes a fourth number of depth values arranged together to form a refined depth map 1410. Refined depth map 1410 may include depth values refined based on second depth values 1406 and refined depth map 1410. For example, refined depth map 1410 may be an example of refined depth map 1314 of FIG. 13. For example, modifier 1312 of FIG. 13 may apply an active filter to depth values (e.g., first depth values 1404, second depth values 1406, and/or third depth values 1408) to generate refined depth map 1410.

Refined depth map 1410 may be better than depth maps generated by other techniques. For example, by refining refined depth map 1410 based on second depth values 1406 and third depth values 1408, modifier 1312 of FIG. 13 may improve depth smoothing and/or hole filling.

For example, depth values may be smoothed based on a confidence interval and/or based on peaks of a multi-peak distribution profile rather than just based on neighboring depth values.

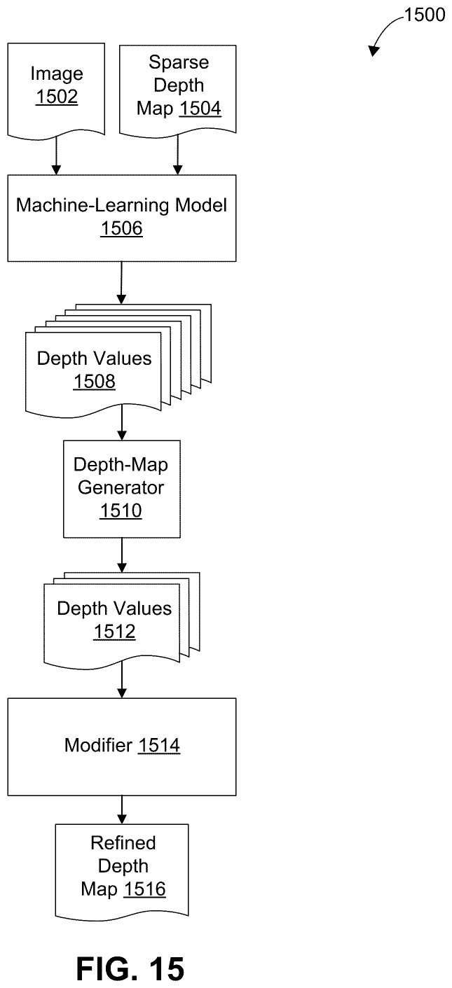

FIG. 15 is a block diagram illustrating an example system 1500 for generating a refined depth map 1516 based on depth values 1512, according to various aspects of the present disclosure. For example, in some aspects, system 1500 may obtain image 1502 and sparse depth map 1504. System 1500 may use machine-learning model 1506 to generate depth values 1508 based on image 1502 and sparse depth map 1504. Depth-map generator 1510 may generate depth values 1512 based on depth values 1508. Modifier 1514 may generate refined depth map 1516 based on depth values 1512. System 1500 may smooth or otherwise correct sparse depth map 1504, and/or add depth values (e.g., to add density to sparse depth map 1504).

Image 1502 may include an image captured by an image sensor. Image 1502 may be a color image including, for example, red, green, and blue pixel values.

Sparse depth map 1504 may be captured according to a projection-based depth-estimation technique. Sparse depth map 1504 may be sparse. For example, sparse depth map 1504 may include relatively few depth values. System 1500 may add depth values to cause refined depth map 1516 to be more dense than sparse depth map 1504. Additionally or alternatively, sparse depth map 1504 may include holes (e.g., depth pixels without depth values). Additionally or alternatively, sparse depth map 1504 may include pixels with bad depth values (e.g., depth values based on a multi-path reflection or noise).

Machine-learning model 1506 may generate depth values 1508 based on image 1502 and sparse depth map 1504. Machine-learning model 1506 may be an example of machine-learning model 504 of FIG. 5.

Depth values 1508 may be, or may include, a depth map including multiple depth values for each depth pixel of the depth map. Depth values 1508 may be an example of depth values 602 of FIG. 6. For example, machine-learning model 1506 may generate depth values 1508 to include multiple depth values and/or a confidence interval or confidence score for each depth pixel of a depth map.

In some aspects, depth-map generator 1510 may generate depth values 1512 based on depth values 1508. Depth values 1512 may include three (or more) depth values for each depth pixel of a depth map. Depth-map generator 1510 may be an example of depth-map generator 614 of FIG. 6.

Depth values 1512 may include three or more depth values per depth pixel of a depth map. Depth-map generator 1510 may be an example of depth values 616 of FIG. 6. For some of the depth pixels, depth values 1512 may include depth values representing a confidence interval and for others depth values 1512 may include depth values representing peaks of a multi-peak distribution profile.

In some aspects, modifier 1514 may modify depth values 1512 to generate refined depth map 1516. In other aspects, depth-map generator 1510 may be omitted from system 1500 and modifier 1514 may modify depth values 1508 to generate refined depth map 1516. In some aspects, modifier 1514 may apply an active filter to depth values 1512 to generate refined depth map 1516. For example, modifier 1514 may apply a bilateral filter to depth values 1512. The bilateral filter may filter the depth values 1512 based on distance and variance. The active filter may be the same as, may be substantially similar to, and/or may perform the same, or substantially the same, operations as the active filter described with regard to refined depth map 1314 of FIG. 13.

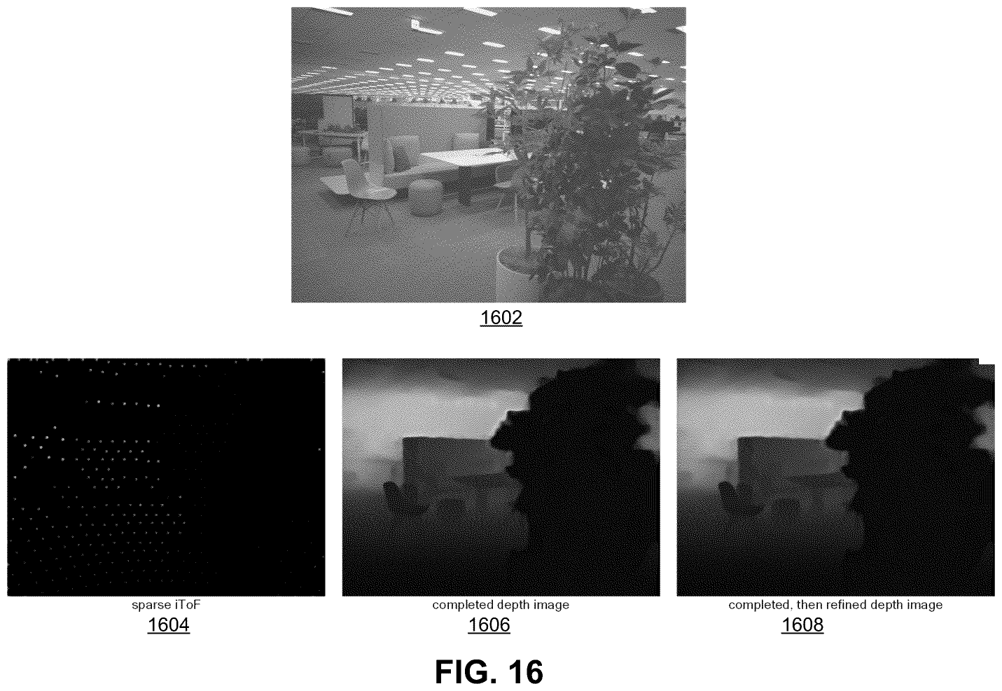

FIG. 16 includes an example image 1602 and three example depth maps corresponding to image 1602. FIG. 16 illustrates results of a depth refining process, according to various aspects of the present disclosure. The depth values are illustrated in FIG. 16 as a grayscale representations of depth values. For example, dark points may represent depth pixels with close depth values and light points may represent depth pixels with distant depth values. Image 1602 is a grayscale image of a scene as captured by a camera. In practice, image 1602 may be a color image.

FIG. 16 includes a sparse depth map 1604 which may be captured or determined as representing depths within the scene. Sparse depth map 1604 may represent depth values as captured according to a projection-based depth-estimation technique. Sparse depth map 1604 may be an example of sparse depth map 1504 of FIG. 15. Sparse depth map 1604 may be sparse. For example, sparse depth map 1604 may include as many depth pixels as filled depth map 1606 and/or refined depth map 1608. However, sparse depth map 1604 may include depth values for relatively few of the depth pixels.

FIG. 16 also includes a second number of depth values arranged together to form a filled depth map 1606. Filled depth map 1606 may be generated by a machine-learning-based depth-estimation technique. The machine-learning-based depth-estimation technique may use image 1602 and sparse depth map 1604 as inputs and generate filled depth map 1606 based on both image 1602 and sparse depth map 1604. For example, machine-learning model 504 of FIG. 5 or machine-learning model 1506 of FIG. 15 may generate filled depth map 1606 based on image 1602 and sparse depth map 1604 in the same way that machine-learning model 504 generates depth map 506 based on image 502 and sparse depth map 508.

Filled depth map 1606 may be generated to include multiple depth values per depth pixel. For example, filled depth map 1606 may be generated by a machine-learning model that may generate multiple depth values per depth pixel. The multiple depth values per depth pixel may represent a confidence interval and/or confidence scores. As such, filled depth map 1606 may be an example of depth values 1508 of FIG. 15. Further, in some aspects, the multiple depth values may be used to generate depth values including three (or more) depth values per depth pixel. For example, filled depth map 1606 may be an example of depth values 1512 of FIG. 15. For example, depth-map generator 1510 may determine three depth values per depth pixels based on depth values 1508.

FIG. 16 also includes refined depth map 1608. Refined depth map 1608 may include depth values refined based on a depth map including three or more depth values per depth pixel (e.g., depth values 616 of FIG. 6). For example, refined depth map 1608 may be an example of refined depth map 1516 of FIG. 15. For example, modifier 1514 of FIG. 15 may apply an active filter to depth values (e.g., of filled depth map 1606) to generate refined depth map 1608.

Refined depth map 1608 may be better than depth maps generated by other techniques. For example, by refining refined depth map 1608 based on multiple depth values per depth pixel, modifier 1514 of FIG. 15 may improve depth smoothing and/or hole filling. For example, depth values may be smoothed based on a confidence interval and/or based on peaks of a multi-peak distribution profile rather than just based on neighboring depth values.

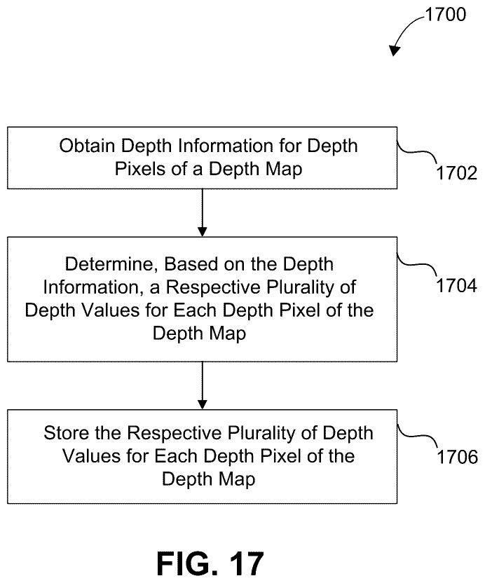

FIG. 17 is a flow diagram illustrating an example process 1700 for storing depth values, in accordance with aspects of the present disclosure. One or more operations of process 1700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 1700. The one or more operations of process 1700 may be implemented as software components that are executed and run on one or more processors.

At block 1702, a computing device (or one or more components thereof) may obtain depth information for depth pixels of a depth map. For example, depth-map generator 614 of FIG. 6 may obtain depth values 602. Depth values 602 may include depth values for each of a number of depth pixels of a depth map. For example, depth values 602 may include depth values 604 for depth pixel 606 and depth values 608 for depth pixel 610.

In some aspects, the depth information may be, or may include, a plurality of depth-measurement values measured by at least one of: a light detection and ranging (LIDAR) depth sensor; a radio detection and ranging (RADAR) depth sensor; a direct time-of-flight (dToF) depth sensor; or an indirect time-of-flight (iToF) depth sensor. For example, depth values 602 may be measured by a LIDAR depth sensor, a RADAR depth sensor, a dTOF depth sensor, and/or an iTOF depth sensor. In some aspects, the depth information may be, or may include, a plurality of depth-measurement values measured at different times. For example, each of depth values 604 may be measured at a different time.

In some aspects, wherein the depth information may be, or may include, a plurality of depth-estimation values estimated by at least one of: a structured-light depth estimator; a depth-from-stereo (DFS) depth estimator; a machine-learning depth predictor; a light detection and ranging (LIDAR) depth sensor; a radio detection and ranging (RADAR) depth sensor; a direct time-of-flight (dToF) depth sensor; or an indirect time-of-flight (iToF) depth sensor. For example, depth values 602 may be estimated using a structured-light depth estimator, a DFS depth estimator, a machine-learning depth predictor, a LIDAR depth sensor, a RADAR depth sensor, a dTOF depth sensor, and/or an iTOF depth sensor. In some aspects, the depth information may be, or may include, a depth-estimate value and a confidence relative to the depth-estimate value. For example, depth values 604 may include one depth value and a confidence value relative to the depth value.

At block 1704, the computing device (or one or more components thereof) may determine, based on the depth information, a respective plurality of depth values for each depth pixel of the depth map. For example, depth-map generator 614 may determine depth values 618 based on depth values 602. Depth values 616 may include a plurality of depth values for each depth pixel of depth map 612. For example, depth-map generator 614 may determine depth values 618 for depth pixel 606 and depth values 622 for depth pixel 610.

At block 1706, the computing device (or one or more components thereof) may store the respective plurality of depth values for each depth pixel of the depth map. For example, depth-map generator 614 may store depth values 616.

In some aspects, the respective plurality of depth values of a depth pixel of the depth map may be, or may include: a first depth value based on depth information corresponding to the depth pixel; a second depth value based on the depth information corresponding to the depth pixel; and a third depth value based on the depth information corresponding to the depth pixel. For example, depth values 616 may include three (or more) depth values for each depth pixel of depth map 612. For example, depth values 618 may include three (or more) depth values for depth pixel 606.

In some aspects, the first depth value and the second depth value represent a confidence interval for the respective plurality of depth values of the depth pixel. The first and second depth values corresponding to a depth pixel may represent a confidence interval for all of the depth values of depth values 602 corresponding to the depth pixel.

In some aspects, the first depth value is based on a minimum depth value of depth values of the depth information corresponding to the depth pixel; and the second depth value is based on a maximum depth value of the depth values of the depth information corresponding to the depth pixel.

In some aspects, the third depth value may be based on at least one of: an average of depth values of the depth information corresponding to the depth pixel; a median of the depth values of the depth information corresponding to the depth pixel; or a likely depth value based on the depth values of the depth information corresponding to the depth pixel. For example, for each depth pixel of depth map 612, a third depth value of depth values 616 may be based on an average of depth values 602 corresponding to the depth pixel, an median of depth values 602 corresponding to the depth pixel, or a likely depth value of depth values 602 corresponding to the depth pixel.

Alternatively, the first and second depth values may be related to peaks of a multi-peak distribution profile. In some aspects, the first depth value may represent a foreground depth and the second depth value may represent a background depth.

In some aspects, the third depth value may be based on at least one of: a reflectivity of a point in a scene corresponding to the depth pixel; an opacity of the point in the scene corresponding to the depth pixel; a pixel coverage between a foreground and a background; a count of a mode of depth values of the depth information corresponding to the depth pixel; or a confidence related to one or both of the first depth value and the second depth value. For example, for each depth pixel of depth map 612, a third depth value of depth values 616 may be based on an opacity of the point in the scene corresponding to the depth pixel; a pixel coverage between a foreground and a background; a count of a mode of depth values of the depth information corresponding to the depth pixel; and/or a confidence related to one or both of the first depth value and the second depth value.

In some aspects, the computing device (or one or more components thereof) may determine whether depth values of the depth information corresponding to the depth pixel exhibit a single-peak distribution profile or a multi-peak distribution profile; in response to determining that the depth values of the depth information corresponding to the depth pixel exhibit a single-peak distribution profile, determine the third depth value based on at least one of: an average of depth values of the depth information corresponding to the depth pixel; a median of the depth values of the depth information corresponding to the depth pixel; or a likely depth value based on the depth values of the depth information corresponding to the depth pixel; and in response to determining that the depth values of the depth information corresponding to the depth pixel exhibit a multi-peak distribution profile, determine the third depth value based on at least one of: a reflectivity of a point in a scene corresponding to the depth pixel; an opacity of the point in the scene corresponding to the depth pixel; a pixel coverage between a foreground and a background; a count of a mode of the depth values of the depth information corresponding to the depth pixel; or a confidence related to one or both of the first depth value and the second depth value. For example, depth-map generator 614 of FIG. 6 may determine, for each depth pixel of depth values 602, whether the depth pixels exhibits a single-peak distribution profile (e.g., as illustrated by histogram 702 of FIG. 7) or a multi-peak distribution profile, (e.g., as illustrated by histogram 704 of FIG. 7). In response to determining that a given depth pixel of depth values 602 corresponds to a single-peak distribution profile, depth-map generator 614 may determine a third depth value corresponding to the given depth pixel based on at least one of: an average of depth values 602 corresponding to the given depth pixel; a median of the depth values 602 corresponding to the depth pixel; and/or a likely depth value based on the depth values 602 corresponding to the depth pixel. In response to determining that a given depth pixel of depth values 602 corresponds to a multi-peak distribution profile, depth-map generator 614 may determine the third depth value of corresponding to the given depth pixel based on at least one of: a reflectivity of a point in a scene corresponding to the given depth pixel; an opacity of the point in the scene corresponding to the given depth pixel; a pixel coverage between a foreground and a background; a count of a mode of the depth values 602 corresponding to the given depth pixel; and/or a confidence related to one or both of the first depth value and the second depth value.

In some aspects, the computing device (or one or more components thereof) may refine the depth map based on respective pluralities of depth values of depth pixels of the depth map. For example, modifier 1312 of system 1300 of FIG. 13 may refine depth values 1304. In some aspects, the computing device (or one or more components thereof) may refine the depth map using an active filter. For example, modifier 1312 may refine depth values 1304 using an active filter. In some aspects, the active filter may be configured to filter a depth value of a depth pixel of the depth map based on respective pluralities of depth values of each neighboring depth pixels of the depth pixel.

In some aspects, the computing device (or one or more components thereof) may modify an image based on respective pluralities of depth values of depth pixels of the depth map. For example, system 1100 of FIG. 11 may modify image 1102 based on depth values 1104.

In some aspects, to modify the image, the computing device (or one or more components thereof) may: determine, based on the respective plurality of depth values of a depth pixel, whether to blur one or more image pixels of an image, wherein the one or more image pixels correspond to the depth pixel; and in response to determining to blur the one or more image pixels: blur a first instance of the one or more image pixels based on a first depth value of the respective plurality of depth values of the depth pixel to generate a first blurred instance of the one or more image pixels; blur a second instance of the one or more image pixels of the image based on a second depth value of the respective plurality of depth values of the depth pixel to generate a second blurred instance of the one or more image pixels; and blend the first blurred instance of the one or more image pixels with the second blurred instance of the one or more image pixels. For example, to modify image 1102, system 1100 may, for a given pixel (or group of pixels) of image 1102, system 1100 may determine to blur the given pixel based on depth values 1104 corresponding to the given pixel. System 1100, using modifier 1112, may blur a first instance of the given pixel to generate image 1116. System 1100, using modifier 1114, may blur a second instance of the given pixel to generate image 1118. System 1100 may blend the blurred first instance of the given pixel and the second instance of the blurred pixel, for example, at modifier 1120, to generate modified image 1122.

In some aspects, the first blurred instance of the one or more image pixels is blended with the second blurred instance of the one or more image pixels based on a third depth value of the respective plurality of depth values of the depth pixel. For example, system 1100 may blend image 1116 with image 1118 based on depth value 1110.

In some aspects, the third depth value of the respective plurality of depth values may be based on a count of a mode of depth values of the depth information corresponding to the depth pixel. For example, depth value 1110 may be based on a mode of the ones of depth values 1104 that correspond to the given pixel of image 1102.

In some aspects, the computing device (or one or more components thereof) may determine whether to blur the one or more image pixels based on a first depth value of the respective plurality of depth values of the depth pixel and wherein the first depth value of the respective plurality of depth values is based on a minimum of depth values of the depth information corresponding to the depth pixel. For example, system 1100 may determine to blur the pixels of image 1102 based on depth values of the given depth pixel based on depth value 1106. Depth value 1106 may be a minimum depth values of the ones of depth values 1104 that relate to the given pixel of image 1102.

In some aspects, the computing device (or one or more components thereof) may determine whether to blur the one or more image pixels based on a confidence related to the respective plurality of depth values of the depth pixel. For example, system 1100 may determine to blend pixels of image 1102 based on a confidence related to depth values of depth values 1104 that correspond to the given pixel of image 1102.

In some aspects, the computing device (or one or more components thereof) may generate additional depth values for the depth map based on the respective plurality of depth values of depth pixels of the depth map. For example, system 1500 of FIG. 15 may generate additional depth values for sparse depth map 1504 based on sparse depth map 1504.

In some aspects, the computing device (or one or more components thereof) may provide the depth map to a machine-learning model trained to inpaint depth values; and obtain from the machine-learning model the additional depth values. For example, system 1500 may provide image 1502 and sparse depth map 1504 to machine-learning model 1506 and 1506/may generate additional depth values in depth values 1508.

In some aspects, the computing device (or one or more components thereof) may fit a three-dimensional plane to the depth map based on the respective plurality of depth values of depth pixels of the depth map.

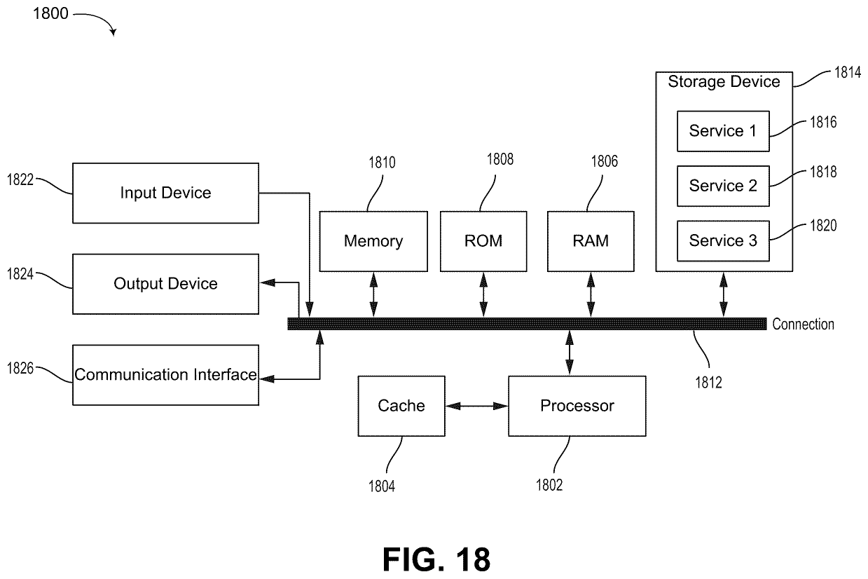

In some examples, as noted previously, the methods described herein (e.g., process 1700 of FIG. 17, and/or other methods described herein) can be performed, in whole or in part, by a computing device or apparatus. In one example, one or more of the methods can be performed by system 600 of FIG. 6, depth-map generator 614 of FIG. 6, depth-map generator 1510 of FIG. 15, or by another system or device. In another example, one or more of the methods (e.g., process 1700 of FIG. 17, and/or other methods described herein) can be performed, in whole or in part, by the computing-device architecture 1800 shown in FIG. 18. For instance, a computing device with the computing-device architecture 1800 shown in FIG. 18 can include, or be included in, the components of the system 600, depth-map generator 614, and/or depth-map generator 1510 and can implement the operations of process 1700, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 1700, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1700, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 18 illustrates an example computing-device architecture 1800 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1800 may include, implement, or be included in any or all of system 600 of FIG. 6 depth-map generator 614 of FIG. 6, system 1100 of FIG. 11, system 1300 of FIG. 13, system 1500 of FIG. 15. Additionally or alternatively, computing-device architecture 1800 may be configured to perform process 1700 of FIG. 17, and/or other process described herein.

The components of computing-device architecture 1800 are shown in electrical communication with each other using connection 1812, such as a bus. The example computing-device architecture 1800 includes a processing unit (CPU or processor) 1802 and computing device connection 1812 that couples various computing device components including computing device memory 1810, such as read only memory (ROM) 1808 and random-access memory (RAM) 1806, to processor 1802.

Computing-device architecture 1800 can include a cache of high-speed memory connected directly with, in close proximity to, or integrated as part of processor 1802. Computing-device architecture 1800 can copy data from memory 1810 and/or the storage device 1814 to cache 1804 for quick access by processor 1802. In this way, the cache can provide a performance boost that avoids processor 1802 delays while waiting for data. These and other modules can control or be configured to control processor 1802 to perform various actions. Other computing device memory 1810 may be available for use as well. Memory 1810 can include multiple different types of memory with different performance characteristics. Processor 1802 can include any general-purpose processor and a hardware or software service, such as service 1 1816, service 2 1818, and service 3 1820 stored in storage device 1814, configured to control processor 1802 as well as a special-purpose processor where software instructions are incorporated into the processor design. Processor 1802 may be a self-contained system, containing multiple cores or processors, a bus, memory controller, cache, etc. A multi-core processor may be symmetric or asymmetric.

To enable user interaction with the computing-device architecture 1800, input device 1822 can represent any number of input mechanisms, such as a microphone for speech, a touch-sensitive screen for gesture or graphical input, keyboard, mouse, motion input, speech and so forth. Output device 1824 can also be one or more of a number of output mechanisms known to those of skill in the art, such as a display, projector, television, speaker device, etc. In some instances, multimodal computing devices can enable a user to provide multiple types of input to communicate with computing-device architecture 1800. Communication interface 1826 can generally govern and manage the user input and computing device output. There is no restriction on operating on any particular hardware arrangement and therefore the basic features here may easily be substituted for improved hardware or firmware arrangements as they are developed.

Storage device 1814 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 1806, read only memory (ROM) 1808, and hybrids thereof. Storage device 1814 can include services 1816, 1818, and 1820 for controlling processor 1802. Other hardware or software modules are contemplated. Storage device 1814 can be connected to the computing device connection 1812. In one aspect, a hardware module that performs a particular function can include the software component stored in a computer-readable medium in connection with the necessary hardware components, such as processor 1802, connection 1812, output device 1824, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:
Aspect 1. An apparatus for storing depth information, the apparatus comprising: at least one memory; and at least one processor coupled to the at least one memory and configured to: obtain depth information for depth pixels of a depth map; determine, based on the depth information, a respective plurality of depth values for each depth pixel of the depth map; and store the respective plurality of depth values for each depth pixel of the depth map.
Aspect 2. The apparatus of aspect 1, wherein the depth information comprises a plurality of depth-measurement values measured by at least one of: a light detection and ranging (LIDAR) depth sensor; a radio detection and ranging (RADAR) depth sensor; a direct time-of-flight (dToF) depth sensor; or an indirect time-of-flight (iToF) depth sensor.
Aspect 3. The apparatus of any one of aspects 1 or 2, wherein the depth information comprises a plurality of depth-measurement values measured at different times.
Aspect 4. The apparatus of any one of aspects 1 to 3, wherein the depth information comprises a plurality of depth-estimation values estimated by at least one of: a structured-light depth estimator; a depth-from-stereo (DFS) depth estimator; a machine-learning depth predictor; a light detection and ranging (LIDAR) depth sensor; a radio detection and ranging (RADAR) depth sensor; a direct time-of-flight (dToF) depth sensor; or an indirect time-of-flight (iToF) depth sensor.
Aspect 5. The apparatus of any one of aspects 1 to 4, wherein the depth information comprises a depth-estimate value and a confidence relative to the depth-estimate value.
Aspect 6. The apparatus of any one of aspects 1 to 5, wherein the respective plurality of depth values of a depth pixel of the depth map comprise: a first depth value based on depth information corresponding to the depth pixel; a second depth value based on the depth information corresponding to the depth pixel; and a third depth value based on the depth information corresponding to the depth pixel.
Aspect 7. The apparatus of aspect 6, wherein the third depth value is based on at least one of: an average of depth values of the depth information corresponding to the depth pixel; a median of the depth values of the depth information corresponding to the depth pixel; or a likely depth value based on the depth values of the depth information corresponding to the depth pixel.
Aspect 8. The apparatus of any one of aspects 6 or 7, wherein the first depth value and the second depth value represent a confidence interval for the respective plurality of depth values of the depth pixel.
Aspect 9. The apparatus of any one of aspects 6 to 8, wherein: the first depth value is based on a minimum depth value of depth values of the depth information corresponding to the depth pixel; and the second depth value is based on a maximum depth value of the depth values of the depth information corresponding to the depth pixel.
Aspect 10. The apparatus of any one of aspects 6 to 9, wherein the third depth value is based on at least one of: a reflectivity of a point in a scene corresponding to the depth pixel; an opacity of the point in the scene corresponding to the depth pixel; a pixel coverage between a foreground and a background; a count of a mode of depth values of the depth information corresponding to the depth pixel; or a confidence related to one or both of the first depth value and the second depth value.
Aspect 11. The apparatus of any one of aspects 6 to 10, wherein: the first depth value represents a foreground depth; and the second depth value represents a background depth.
Aspect 12. The apparatus of any one of aspects 6 to 11, wherein the at least one processor is further configured to: determine whether depth values of the depth information corresponding to the depth pixel exhibit a single-peak distribution profile or a multi-peak distribution profile; in response to determining that the depth values of the depth information corresponding to the depth pixel exhibit a single-peak distribution profile, determine the third depth value based on at least one of: an average of depth values of the depth information corresponding to the depth pixel; a median of the depth values of the depth information corresponding to the depth pixel; or a likely depth value based on the depth values of the depth information corresponding to the depth pixel; and in response to determining that the depth values of the depth information corresponding to the depth pixel exhibit a multi-peak distribution profile, determine the third depth value based on at least one of: a reflectivity of a point in a scene corresponding to the depth pixel; an opacity of the point in the scene corresponding to the depth pixel; a pixel coverage between a foreground and a background; a count of a mode of the depth values of the depth information corresponding to the depth pixel; or a confidence related to one or both of the first depth value and the second depth value.
Aspect 13. The apparatus of any one of aspects 1 to 12, wherein the at least one processor is further configured to refine the depth map based on respective pluralities of depth values of depth pixels of the depth map.
Aspect 14. The apparatus of aspect 13, wherein the depth map is refined using an active filter.
Aspect 15. The apparatus of aspect 14, wherein the active filter is configured to filter a depth value of a depth pixel of the depth map based on respective pluralities of depth values of each neighboring depth pixels of the depth pixel.
Aspect 16. The apparatus of any one of aspects 1 to 15, wherein the at least one processor is further configured to modify an image based on respective pluralities of depth values of depth pixels of the depth map.
Aspect 17. The apparatus of aspect 16, wherein, to modify the image, the at least one processor is configured to: determine, based on the respective plurality of depth values of a depth pixel, whether to blur one or more image pixels of an image, wherein the one or more image pixels correspond to the depth pixel; and in response to determining to blur the one or more image pixels: blur a first instance of the one or more image pixels based on a first depth value of the respective plurality of depth values of the depth pixel to generate a first blurred instance of the one or more image pixels; blur a second instance of the one or more image pixels of the image based on a second depth value of the respective plurality of depth values of the depth pixel to generate a second blurred instance of the one or more image pixels; and blend the first blurred instance of the one or more image pixels with the second blurred instance of the one or more image pixels.
Aspect 18. The apparatus of aspect 17, wherein the first blurred instance of the one or more image pixels is blended with the second blurred instance of the one or more image pixels based on a third depth value of the respective plurality of depth values of the depth pixel.
Aspect 19. The apparatus of aspect 18, wherein the third depth value of the respective plurality of depth values is based on a count of a mode of depth values of the depth information corresponding to the depth pixel.
Aspect 20. The apparatus of any one of aspects 17 to 19, wherein the at least one processor is configured to determine whether to blur the one or more image pixels based on a first depth value of the respective plurality of depth values of the depth pixel and wherein the first depth value of the respective plurality of depth values is based on a minimum of depth values of the depth information corresponding to the depth pixel.
Aspect 21. The apparatus of any one of aspects 17 to 20, wherein the at least one processor is configured to determine whether to blur the one or more image pixels based on a confidence related to the respective plurality of depth values of the depth pixel.
Aspect 22. The apparatus of any one of aspects 1 to 21, wherein the at least one processor is further configured to generating additional depth values for the depth map based on the respective plurality of depth values of depth pixels of the depth map.
Aspect 23. The apparatus of aspect 22, wherein the at least one processor is further configured to: provide the depth map to a machine-learning model trained to inpaint depth values; and obtain from the machine-learning model the additional depth values.
Aspect 24. The apparatus of any one of aspects 1 to 23, wherein the at least one processor is further configured to generate a three-dimensional model of a scene based on the respective plurality of depth values of depth pixels of the depth map.
Aspect 25. The apparatus of aspect 24, wherein the at least one processor is further configured to fit a three-dimensional plane to the depth map based on the respective plurality of depth values of depth pixels of the depth map.
Aspect 26. A method for storing depth information, the method comprising: obtain depth information for depth pixels of a depth map; determine, based on the depth information, a respective plurality of depth values for each depth pixel of the depth map; and store the respective plurality of depth values for each depth pixel of the depth map.
Aspect 27. The method of aspect 26, wherein the depth information comprises a plurality of depth-measurement values measured by at least one of: a light detection and ranging (LIDAR) depth sensor; a radio detection and ranging (RADAR) depth sensor; a direct time-of-flight (dToF) depth sensor; or an indirect time-of-flight (iToF) depth sensor.
Aspect 28. The method of any one of aspects 26 or 27, wherein the depth information comprises a plurality of depth-measurement values measured at different times.
Aspect 29. The method of any one of aspects 26 to 28, wherein the depth information comprises a plurality of depth-estimation values estimated by at least one of: a structured-light depth estimator; a depth-from-stereo (DFS) depth estimator; a machine-learning depth predictor; a light detection and ranging (LIDAR) depth sensor; a radio detection and ranging (RADAR) depth sensor; a direct time-of-flight (dToF) depth sensor; or an indirect time-of-flight (iToF) depth sensor.
Aspect 30. The method of any one of aspects 26 to 29, wherein the depth information comprises a depth-estimate value and a confidence relative to the depth-estimate value.
Aspect 31. The method of any one of aspects 26 to 30, wherein the respective plurality of depth values of a depth pixel of the depth map comprise: a first depth value based on depth information corresponding to the depth pixel; a second depth value based on the depth information corresponding to the depth pixel; and a third depth value based on the depth information corresponding to the depth pixel.
Aspect 32. The method of aspect 31, wherein the third depth value is based on at least one of: an average of depth values of the depth information corresponding to the depth pixel; a median of the depth values of the depth information corresponding to the depth pixel; or a likely depth value based on the depth values of the depth information corresponding to the depth pixel.
Aspect 33. The method of any one of aspects 31 or 32, wherein the first depth value and the second depth value represent a confidence interval for the respective plurality of depth values of the depth pixel.
Aspect 34. The method of any one of aspects 31 to 33, wherein: the first depth value is based on a minimum depth value of depth values of the depth information corresponding to the depth pixel; and the second depth value is based on a maximum depth value of the depth values of the depth information corresponding to the depth pixel.
Aspect 35. The method of any one of aspects 31 to 34, wherein the third depth value is based on at least one of: a reflectivity of a point in a scene corresponding to the depth pixel; an opacity of the point in the scene corresponding to the depth pixel; a pixel coverage between a foreground and a background; a count of a mode of depth values of the depth information corresponding to the depth pixel; or a confidence related to one or both of the first depth value and the second depth value.
Aspect 36. The method of any one of aspects 31 to 35, wherein: the first depth value represents a foreground depth; and the second depth value represents a background depth.
Aspect 37. The method of any one of aspects 31 to 36, further comprising: determining whether depth values of the depth information corresponding to the depth pixel exhibit a single-peak distribution profile or a multi-peak distribution profile; in response to determining that the depth values of the depth information corresponding to the depth pixel exhibit a single-peak distribution profile, determining the third depth value based on at least one of: an average of depth values of the depth information corresponding to the depth pixel; a median of the depth values of the depth information corresponding to the depth pixel; or a likely depth value based on the depth values of the depth information corresponding to the depth pixel; and in response to determining that the depth values of the depth information corresponding to the depth pixel exhibit a multi-peak distribution profile, determining the third depth value based on at least one of: a reflectivity of a point in a scene corresponding to the depth pixel; an opacity of the point in the scene corresponding to the depth pixel; a pixel coverage between a foreground and a background; a count of a mode of the depth values of the depth information corresponding to the depth pixel; or a confidence related to one or both of the first depth value and the second depth value.
Aspect 38. The method of any one of aspects 26 to 37, further comprising refining the depth map based on respective pluralities of depth values of depth pixels of the depth map.
Aspect 39. The method of aspect 38, wherein the depth map is refined using an active filter.
Aspect 40. The method of aspect 39, wherein the active filter is configured to filter a depth value of a depth pixel of the depth map based on respective pluralities of depth values of each neighboring depth pixels of the depth pixel.
Aspect 41. The method of any one of aspects 26 to 40, further comprising modifying an image based on respective pluralities of depth values of depth pixels of the depth map.
Aspect 42. The method of aspect 41, wherein modifying the image comprises: determining, based on the respective plurality of depth values of a depth pixel, whether to blur one or more image pixels of an image, wherein the one or more image pixels correspond to the depth pixel; and in response to determining to blur the one or more image pixels: blurring a first instance of the one or more image pixels based on a first depth value of the respective plurality of depth values of the depth pixel to generate a first blurred instance of the one or more image pixels; blurring a second instance of the one or more image pixels of the image based on a second depth value of the respective plurality of depth values of the depth pixel to generate a second blurred instance of the one or more image pixels; and blending the first blurred instance of the one or more image pixels with the second blurred instance of the one or more image pixels.
Aspect 43. The method of aspect 42, wherein the first blurred instance of the one or more image pixels is blended with the second blurred instance of the one or more image pixels based on a third depth value of the respective plurality of depth values of the depth pixel.
Aspect 44. The method of aspect 43, wherein the third depth value of the respective plurality of depth values is based on a count of a mode of depth values of the depth information corresponding to the depth pixel.
Aspect 45. The method of any one of aspects 42 to 44, wherein determining whether to blur the one or more image pixels is based on a first depth value of the respective plurality of depth values of the depth pixel and wherein the first depth value of the respective plurality of depth values is based on a minimum of depth values of the depth information corresponding to the depth pixel.
Aspect 46. The method of any one of aspects 42 to 45, wherein determining whether to blur the one or more image pixels is based on a confidence related to the respective plurality of depth values of the depth pixel.
Aspect 47. The method of any one of aspects 26 to 46, further comprising generating additional depth values for the depth map based on the respective plurality of depth values of depth pixels of the depth map.
Aspect 48. The method of aspect 47, further comprising: providing the depth map to a machine-learning model trained to inpaint depth values; and obtaining from the machine-learning model the additional depth values.
Aspect 49. The method of any one of aspects 26 to 48, further comprising generating a three-dimensional model of a scene based on the respective plurality of depth values of depth pixels of the depth map.
Aspect 50. The method of aspect 49, further comprising fitting a three-dimensional plane to the depth map based on the respective plurality of depth values of depth pixels of the depth map.
Aspect 51. A non-transitory computer-readable storage medium having stored thereon instructions that, when executed by at least one processor, cause the at least one processor to perform operations according to any of aspects 26 to 50.
Aspect 52. An apparatus for providing virtual content for display, the apparatus comprising one or more means for perform operations according to any of aspects 26 to 50.

What is claimed is:

1. An apparatus for storing depth information, the apparatus comprising:
at least one memory; and
at least one processor coupled to the at least one memory and configured to:
obtain depth information for depth pixels of a depth map;
determine, based on the depth information, a respective plurality of depth values for each depth pixel of the depth map; and
store the respective plurality of depth values for each depth pixel of the depth map.

2. The apparatus of claim 1, wherein the depth information comprises a plurality of depth-measurement values measured by at least one of:
a light detection and ranging (LIDAR) depth sensor;
a radio detection and ranging (RADAR) depth sensor;
a direct time-of-flight (dToF) depth sensor; or
an indirect time-of-flight (iToF) depth sensor.

3. The apparatus of claim 1, wherein the depth information comprises a plurality of depth-measurement values measured at different times.

4. The apparatus of claim 1, wherein the depth information comprises a plurality of depth-estimation values estimated by at least one of:
a structured-light depth estimator;
a depth-from-stereo (DFS) depth estimator;
a machine-learning depth predictor;
a light detection and ranging (LIDAR) depth sensor;
a radio detection and ranging (RADAR) depth sensor;
a direct time-of-flight (dToF) depth sensor; or
an indirect time-of-flight (iToF) depth sensor.

5. The apparatus of claim 1, wherein the depth information comprises a depth-estimate value and a confidence relative to the depth-estimate value.

6. The apparatus of claim 1, wherein the respective plurality of depth values of a depth pixel of the depth map comprise:
a first depth value based on depth information corresponding to the depth pixel;
a second depth value based on the depth information corresponding to the depth pixel; and
a third depth value based on the depth information corresponding to the depth pixel.

7. The apparatus of claim 6, wherein the third depth value is based on at least one of:
an average of depth values of the depth information corresponding to the depth pixel;
a median of the depth values of the depth information corresponding to the depth pixel; or
a likely depth value based on the depth values of the depth information corresponding to the depth pixel.

8. The apparatus of claim 6, wherein the first depth value and the second depth value represent a confidence interval for the respective plurality of depth values of the depth pixel.

9. The apparatus of claim 6, wherein:
the first depth value is based on a minimum depth value of depth values of the depth information corresponding to the depth pixel; and
the second depth value is based on a maximum depth value of the depth values of the depth information corresponding to the depth pixel.

10. The apparatus of claim 6, wherein the third depth value is based on at least one of:
a reflectivity of a point in a scene corresponding to the depth pixel;
an opacity of the point in the scene corresponding to the depth pixel;
a pixel coverage between a foreground and a background;
a count of a mode of depth values of the depth information corresponding to the depth pixel; or
a confidence related to one or both of the first depth value and the second depth value.

11. The apparatus of claim 6, wherein:
the first depth value represents a foreground depth; and
the second depth value represents a background depth.

12. The apparatus of claim 6, wherein the at least one processor is further configured to:
determine whether depth values of the depth information corresponding to the depth pixel exhibit a single-peak distribution profile or a multi-peak distribution profile;
in response to determining that the depth values of the depth information corresponding to the depth pixel exhibit a single-peak distribution profile, determine the third depth value based on at least one of:
an average of depth values of the depth information corresponding to the depth pixel;
a median of the depth values of the depth information corresponding to the depth pixel; or
a likely depth value based on the depth values of the depth information corresponding to the depth pixel; and
in response to determining that the depth values of the depth information corresponding to the depth pixel exhibit a multi-peak distribution profile, determine the third depth value based on at least one of:
a reflectivity of a point in a scene corresponding to the depth pixel;
an opacity of the point in the scene corresponding to the depth pixel;
a pixel coverage between a foreground and a background;
a count of a mode of the depth values of the depth information corresponding to the depth pixel; or
a confidence related to one or both of the first depth value and the second depth value.

13. The apparatus of claim 1, wherein the at least one processor is further configured to refine the depth map based on respective pluralities of depth values of depth pixels of the depth map.

14. The apparatus of claim 13, wherein the depth map is refined using an active filter.

15. The apparatus of claim 14, wherein the active filter is configured to filter a depth value of a depth pixel of the depth map based on respective pluralities of depth values of each neighboring depth pixels of the depth pixel.

16. The apparatus of claim 1, wherein the at least one processor is further configured to modify an image based on respective pluralities of depth values of depth pixels of the depth map.

17. The apparatus of claim 16, wherein, to modify the image, the at least one processor is configured to:
determine, based on the respective plurality of depth values of a depth pixel, whether to blur one or more image pixels of an image, wherein the one or more image pixels correspond to the depth pixel; and
in response to determining to blur the one or more image pixels:
blur a first instance of the one or more image pixels based on a first depth value of the respective plurality of depth values of the depth pixel to generate a first blurred instance of the one or more image pixels;
blur a second instance of the one or more image pixels of the image based on a second depth value of the respective plurality of depth values of the depth pixel to generate a second blurred instance of the one or more image pixels; and
blend the first blurred instance of the one or more image pixels with the second blurred instance of the one or more image pixels.

18. The apparatus of claim 17, wherein the first blurred instance of the one or more image pixels is blended with the second blurred instance of the one or more image pixels based on a third depth value of the respective plurality of depth values of the depth pixel.

19. The apparatus of claim 18, wherein the third depth value of the respective plurality of depth values is based on a count of a mode of depth values of the depth information corresponding to the depth pixel.

20. The apparatus of claim 17, wherein the at least one processor is configured to determine whether to blur the one or more image pixels based on a first depth value of the respective plurality of depth values of the depth pixel and wherein the first depth value of the respective plurality of depth values is based on a minimum of depth values of the depth information corresponding to the depth pixel.
